(19) United States
(12) Patent Application Publication
(10) Pub. No.: US 2025/0025864 A1
(43) Pub. Date: Jan. 23, 2025

(54) CATALYST FOR HYDROGEN PEROXIDE ACTIVATION

(71) Applicant: BASF SE, Ludwigshafen am Rhein (DE)

(72) Inventors: Andrei-Nicolae PARVULESCU, Ludwigshafen am Rhein (DE); Natalia TRUKHAN, Ludwigshafen am Rhein (DE); Trees Maria DE BAERDEMAEKER, Ludwigshafen am Rhein (DE); Joaquim Henrique TELES, Ludwigshafen am Rhein (DE); Jaroslaw Michael MORMUL, Ludwigshafen am Rhein (DE); Christophe COPERET, Zurich (CH); Lukas LAETSCH, Zurich (CH)

(21) Appl. No.: 18/713,203

(22) PCT Filed: Nov. 29, 2022
(86) PCT No.: PCT/EP2022/083614

§ 371 Date: May 24, 2024

(30) Foreign Application Priority Data
Nov. 29, 2021 (EP) 21211010.0

(51) Int. Cl. B01J 29/89; B01J 37/00

(52) U.S. Cl. CPC B01J 29/89; B01J 37/0009

(57) ABSTRACT

The present invention relates to a catalyst for hydrogen peroxide activation, wherein the catalyst comprises Ti, Si, and O, wherein the catalyst displays a water adsorption (W), a concentration (C) of bridging μ² η²-peroxo species per Ti in the H₂O₂-activated catalyst as determined by quantitative ¹⁷O NMR spectroscopy, and a specific activation factor (A) according to formula I, wherein in accordance with formula I, the activation factor is the multiplication product of the water adsorption and the concentration of bridging μ² η²-peroxo species per Ti in the H₂O₂-activated catalyst:

A=W×C (I).

The present invention further relates to a method for the preparation of a catalyst molding as well as to a catalyst molding comprising a catalyst for hydrogen peroxide activation obtainable or obtained by said process. Yet further, the present invention relates to a process for the activation of hydrogen peroxide, and to the use of the inventive catalyst or of the inventive catalyst molding in a reaction involving C—C bond formation and/or conversion.

### TECHNICAL FIELD

The present invention relates to a catalyst for hydrogen peroxide activation, wherein the catalyst comprises Ti, Si, and O, wherein the catalyst displays a water adsorption (W), a concentration (C) of bridging μ² η²-peroxo species per Ti in the H₂O₂-activated catalyst as determined by quantitative ¹⁷O NMR spectroscopy, and a specific activation factor (A), wherein the activation factor is the multiplication product of the water adsorption and the concentration of bridging μ² η²-peroxo species per Ti in the H₂O₂-activated catalyst. Furthermore, the present invention relates to a method for the preparation of a catalyst molding, as well as to a catalyst molding obtainable or obtained by said process. Yet further, the present invention relates to a process for the activation of hydrogen peroxide, and use of the inventive catalyst or of the inventive catalyst molding in a reaction involving C—C bond formation and/or conversion.

### Introduction

Oxidation reactions such as ammoximation, hydroxylation, and epoxidation reactions are typically carried out in the presence of specific catalysts. In particular, zeolitic materials comprising Si and a further tetravalent element are known to be efficient catalysts, wherein these zeolitic materials are often employed in the form of moldings which, in addition to the catalytically active zeolitic material, comprise a suitable binder.

Such materials are widely used in industry. For example, epoxidation catalysts are employed on a large scale for the epoxidation of olefins with hydrogen peroxide (H₂O₂), leaving only water as a byproduct. In this regard, titanosilicates having an MFI framework structure containing 1-2 wt.-% Ti in which the silicon atoms were substituted for titanium atoms have proven to be efficient catalysts. For instance, U.S. Pat. No. 4,410,501 relates to the preparation of a porous crystalline synthetic material comprising silicon and titanium oxides. WO 2020/074586 A1, on the other hand, relates to a molding comprising a zeolitic material having the framework type MFI.

Titanium silicalite-1 (TS-1), as a specific titanosilicate, was the subject of a study on the efficient epoxidation over its dinuclear sites in C. P. Gordon et al., Nature 2020, 586, 708-713. Generally, it was assumed that the catalytic properties of TS-1 are attributed to the presence of isolated Ti (iv) sites within the zeolite framework. However, as has been found by C. P. Gordon et al. in said study, all sample TS-1 materials exhibited on contact with H₂¹⁷O₂ a characteristic solid-state ¹⁷O nuclear magnetic resonance signature that is indicative of the formation of peroxo species bridging titanium sites. Further, it was found from density functional theory calculations that a cooperativity between said titanium sites enables propylene epoxidation via a low-energy reaction pathway with a key oxygen-transfer transition state similar to that of olefin epoxidation by peroxy acids. Therefore, it was suggested in said study that dinuclear titanium sites, rather than isolated titanium atoms in the framework, explain the high efficiency of TS-1 in propylene epoxidation with H₂O₂.

There however remains a need for the provision of improved catalysts for the activation of hydrogen peroxide, in particular with regard to their catalytic efficiency in epoxidation reactions, and more generally in oxidation reactions based on the conversion of hydrogen peroxide. In particular, there remains a need for an improved process for the activation of hydrogen peroxide where such improved catalysts may be provided.

### DETAILED DESCRIPTION

Thus, it was an object of the present invention to provide an improved catalyst for hydrogen peroxide activation. Taking the above into account, it was a particular object of the present invention to provide a catalyst displaying a specific activation factor which is highly correlated to both the catalytic activity and selectivity of the catalyst, and may thus discern it from existing materials in view of its improved catalytic performance. In addition, it was an object of the present invention to provide an improved process for the activation of hydrogen peroxide, wherein a catalyst displaying a specific activation factor is used.

Surprisingly, it has been found that improved catalysts can be provided displaying unique activation factors. In particular, it was surprisingly found that the multiplication product of the water adsorption and the concentration of bridging μ² η²-peroxo species per metal in the H₂O₂-activated catalyst, as determined by quantitative ¹⁷O NMR spectroscopy, of the inventive catalysts provides a unique activation factor which is not only correlated to its catalytic activity, but furthermore clearly distinguishes the inventive catalysts from those of the art. In addition, it was surprisingly found that an improved process for the activation of hydrogen peroxide can be provided in view of the aforementioned activation factor and the provision of improved catalysts according to the present invention. Thus, it has been found that a catalyst can be provided having unique physical and chemical properties, and that said catalyst allows for an improved catalytic activity, in particular in the activation of hydrogen peroxide for oxidation, and in particular for epoxidation reactions such as the conversion of propylene and hydrogen peroxide to propylene oxide.

Therefore, the present invention relates to a catalyst for hydrogen peroxide activation, wherein the catalyst comprises Ti, Si, and O, wherein the catalyst displays a water adsorption (W), preferably determined according to Reference Example 1.1, a concentration (C) of bridging μ² η²-peroxo species per Ti in the H₂O₂-activated catalyst as determined by quantitative ¹⁷O NMR spectroscopy, preferably determined according to Reference Example 1.3, and an activation factor (A) according to formula I, wherein the activation factor is in the range of from 15 to 80 mmol/mol;
wherein in accordance with formula I, the activation factor is the multiplication product of the water adsorption and the concentration of bridging μ² η²-peroxo species per Ti in the H₂O₂-activated catalyst:

A=W×C (I).

It is preferred that the catalyst displays a water adsorption in the range of from 1 to 10 wt.-%, preferably from 1.5 to 9.5 wt.-%, more preferably from 2 to 9 wt.-%, more preferably from 2.5 to 8.5 wt.-%, more preferably from 3 to 8 wt.-%, more preferably from 3.2 to 7.9 wt.-%, more preferably from 3.5 to 7.5 wt.-%, more preferably from 4 to 7 wt.-%, more preferably from 4.5 to 6.5 wt.-%, and more preferably from 5 to 6 wt.-%. It is noted that for a water adsorption of x wt.-%, said value corresponds to x % g/g=(x/100) g/g=W. Accordingly, by way of example, a water adsorption of 1 wt.-%=1% g/g=0.01 g/g=W. Further and independently thereof, it is preferred that the catalyst displays a concentration of bridging μ² η²-peroxo species per Ti in the H₂O₂-activated catalyst in the range of from 200 to 1,200 mmol/mol, more preferably from 300 to 1,000 mmol/mol, more preferably from 350 to 950 mmol/mol, more preferably from 400 to 900 mmol/mol, more preferably from 450 to 850 mmol/mol, more preferably from 500 to 800 mmol/mol, more preferably from 550 to 750 mmol/mol, and more preferably from 600 to 700 mmol/mol. Further and independently thereof, it is preferred that the concentration (C) of bridging μ² η²-peroxo species per Ti in the H₂O₂-activated catalyst as determined by quantitative ¹⁷O NMR spectroscopy is the concentration which is determined at a time point T after having brought the catalyst into contact with H₂¹⁷O₂, wherein T is in the range of from 1 to 720 min after having brought the catalyst into contact with H₂¹⁷O₂, more preferably from 2 min to 480 min, more preferably from 4 to 240 min, more preferably from 6 to 120 min, more preferably from 8 to 60 min, more preferably from 10 to 30 min, more preferably from 12 to 20 min, and more preferably from 14 to 16 min, wherein more preferably T is 15 min. Further and independently thereof, it is preferred that the activation factor is in the range of from 16 to 70 mmol/mol, more preferably from 18 to 60 mmol/mol, more preferably from 20 to 55 mmol/mol, more preferably from 23 to 50 mmol/mol, more preferably from 25 to 45 mmol/mol, more preferably from 26 to 44 mmol/mol, more preferably from 27 to 42 mmol/mol, more preferably from 28 to 40 mmol/mol, more preferably from 29 to 37 mmol/mol, and more preferably from 30 to 35 mmol/mol.

Alternatively, it is preferred that the catalyst displays a concentration of bridging μ² η²-peroxo species per Ti in the H₂O₂-activated catalyst in the range of from 200 to 825 mmol/mol, wherein the concentration of bridging μ² η²-peroxo species per Ti in the H₂O₂-activated catalyst as determined by quantitative ¹⁷O NMR spectroscopy is the concentration which is determined at a time point T after having brought the catalyst into contact with H₂¹⁷O₂, wherein T is in the range of from 65 to 175 min. Further and independently thereof, it is preferred that the catalyst displays a water adsorption in the range of from 1 to 7.9 wt.-%, more preferably from 3 to 7.5 wt.-%, more preferably from 4 to 7 wt.-%, more preferably from 4.5 to 6.5 wt.-%, and more preferably from 5 to 6 wt.-%. Further and independently thereof, it is preferred that the catalyst displays a concentration of bridging μ² η²-peroxo species per Ti in the H₂O₂-activated catalyst as determined by quantitative ¹⁷O NMR spectroscopy, more preferably determined according to Reference Example 1.3, in the range of from 300 to 822 mmol/mol, more preferably from 350 to 800 mmol/mol, more preferably from 400 to 780 mmol/mol, more preferably from 450 to 760 mmol/mol, more preferably from 500 to 740 mmol/mol, more preferably from 550 to 720 mmol/mol, and more preferably from 600 to 700 mmol/mol. Further and independently thereof, it is preferred that T is in the range of from 75 to 165 min, more preferably from 85 min to 155 min, more preferably from 95 to 145 min, more preferably from 105 to 135 min, more preferably from 112 to 128 min, more preferably from 116 to 124 min, more preferably from 118 to 122 min, and more preferably from 119 to 121 min, wherein more preferably T is 120 min. Further and independently thereof, it is preferred that the activation factor is in the range of from 16 to 75 mmol/mol, more preferably from 18 to 67 mmol/mol, more preferably from 20 to 65 mmol/mol, more preferably from 22 to 60 mmol/mol, more preferably from 24 to 55 mmol/mol, more preferably from 26 to 50 mmol/mol, more preferably from 27 to 45 mmol/mol, more preferably from 28 to 40 mmol/mol, more preferably from 29 to 37 mmol/mol, and more preferably from 30 to 34 mmol/mol.

It is preferred that the catalyst displays a XANES spectrum having a ratio of the intensity of the signal at 4987 eV to the intensity of the signal at 4992 eV in the range of from 0.95:1 to 1.07:1, more preferably of from 0.97:1 to 1.07:1, more preferably in the range of from 0.99:1 to 1.07:1, more preferably in the range of from 1.01:1 to 1.07:1, more preferably in the range of from 1.03:1 to 1.07:1, and more preferably in the range of from 1.05:1 to 1.07:1, wherein the XANES spectrum is more preferably determined according Reference Example 1.2.

It is preferred that the catalyst of the present invention has a BET specific surface area in the range of from 350 to 475 m²/g, more preferably from 370 to 455 m²/g, more preferably from 390 to 435 m²/g, wherein the BET specific surface area is preferably determined according to Reference Example 1.5.

It is preferred that the catalyst of the present invention comprises from 0.5 to 2.5 weight-%, more preferably from 0.8 to 2.0 weight-%, more preferably from 1.0 to 1.9 weight-%, more preferably from 1.0 to 1.8 weight-%, more preferably from 1.1 to 1.3 weight-%, of Ti, calculated as the element and based on the total weight of the catalyst.

It is preferred that the catalyst of the present invention comprises from 0 to 1 weight-%, preferably from 0 to 0.1 weight-%, more preferably from 0 to 0.01 weight-%, more preferably from 0 to 0.001 weight-%, of B, calculated as the element and based on the total weight of the catalyst.

It is preferred that the catalyst of the present invention comprises from 0 to 1 weight-%, preferably from 0 to 0.1 weight-%, more preferably from 0 to 0.01 weight-%, more preferably from 0 to 0.001 weight-%, of Na, calculated as the element and based on the total weight of the catalyst.

It is preferred that the catalyst of the present invention comprises from 0 to 1 weight-%, preferably from 0 to 0.1 weight-%, more preferably from 0 to 0.01 weight-%, more preferably from 0 to 0.001 weight-%, of Ge, calculated as the element and based on the total weight of the catalyst.

It is preferred that the catalyst of the present invention comprises from 0 to 1 weight-%, preferably from 0 to 0.5 weight-%, more preferably from 0 to 0.2 weight-%, more preferably from 0 to 0.1 weight-%, of C, calculated as the element and based on the total weight of the catalyst.

It is preferred that the catalyst of the present invention exhibits a propylene oxide activity of at least 2.0 weight-%, preferably in the range of from 3.0 to 15.0 weight-%, more preferably in the range of from 9.0 to 13.0 weight-%, preferably determined as described in Reference Example 1.6.

It is preferred that the catalyst further comprises one or more metals selected from the group consisting of Zn, Cd, Sn, La, and Ba, including mixtures of two or more thereof.

It is preferred that from 95 to 100 wt.-% of the catalyst consists of Ti, Si, and O, more preferably from 97 to 100 wt.-%, more preferably from 98 to 100 wt.-%, more preferably from 99 to 100 wt.-%, more preferably from 99.5 to 100 wt.-%, and more preferably from 99.9 to 100 wt.-%.

It is preferred that from 95 to 100 wt.-% of the catalyst consists of Ti, Si, O, and H, more preferably from 97 to 100 wt.-%, more preferably from 98 to 100 wt.-%, more preferably from 99 to 100 wt.-%, more preferably from 99.5 to 100 wt.-%, and more preferably from 99.9 to 100 wt.-%.

It is preferred that the catalyst comprises, more preferably consists of, a zeolitic material having a framework structure comprising Si, Ti, and O.

In case where the catalyst comprises a zeolitic material having a framework structure comprising Si, Ti, and O, it is preferred that the zeolitic material having an Si:Ti molar ratio in the range of from 1 to 250, more preferably in the range of from 10 to 150, more preferably in the range of from 20 to 95, more preferably in the range of from 30 to 75, more preferably in the range of from 35 to 70, more preferably in the range of from 40 to 65, more preferably in the range of from 45 to 60, more preferably in the range of from 50 to 55.

Furthermore and independently thereof, in case where the catalyst comprises a zeolitic material having a framework structure comprising Si, Ti, and O, it is preferred that the zeolitic material has a framework structure type selected from the group consisting of MFI, MEL, MWW, ITH, IWR, IMF, SVY, FER, SVR, and intergrowth structures of two or more thereof, more preferably selected from the group consisting of MFI, MEL, MWW, ITH, and IWR, and intergrowth structures of two or more thereof, more preferably selected from the group consisting of MFI, MEL, and intergrowth structures thereof, wherein the zeolitic material more preferably has an MFI-type framework structure. Furthermore and independently thereof, it is preferred that the zeolitic material is a TS-1 zeolite.

Furthermore and independently thereof, it is preferred that the zeolitic material further comprises one or more metals selected from the group consisting of Zn, Cd, Sn, La, and Ba, including mixtures of two or more thereof, wherein the one or more metals are more preferably contained in the pores of the zeolitic material.

Furthermore and independently thereof, it is preferred that from 95 to 100 wt.-% of the zeolitic material consists of Ti, Si, and O, more preferably from 97 to 100 wt.-%, more preferably from 98 to 100 wt.-%, more preferably from 99 to 100 wt.-%, more preferably from 99.5 to 100 wt.-%, and more preferably from 99.9 to 100 wt.-%.

Furthermore and independently thereof, it is preferred that from 95 to 100 wt.-% of the zeolitic material consists of Ti, Si, O, and H, more preferably from 97 to 100 wt.-%, more preferably from 98 to 100 wt.-%, more preferably from 99 to 100 wt.-%, more preferably from 99.5 to 100 wt.-%, and more preferably from 99.9 to 100 wt.-%.

Furthermore and independently thereof, it is preferred that the zeolitic material has a crystallinity in the range of from 50 to 100 weight-%, more preferably from 75 to 100 weight-%, more preferably from 80 to 100 weight-%, and more preferably from 90 to 100 weight-%, wherein the crystallinity is preferably determined as described in Reference Example 1.4.

The present invention also relates to a method for the preparation of a catalyst molding, comprising
(a) providing a catalyst for hydrogen peroxide activation according to any of the particular and preferred embodiments of the present invention;
(b) mixing the catalyst provided in step (a) with one or more binders;
(c) optionally kneading of the mixture obtained in step (b);
(d) molding of the mixture obtained in step (b) or (c) to obtain one or more moldings;
(e) optionally drying of the one or more moldings obtained in step (d); and
(f) calcining of the molding obtained in step (d) or (e).

It is preferred that providing the catalyst in (a) comprises selecting the catalyst among catalysts comprising Ti, Si, and O, and displaying
a water adsorption (W), preferably determined according to Reference Example 1.1, and
a concentration (C) of bridging μ² η²-peroxo species per Ti in the H₂O₂-activated catalyst as determined by quantitative ¹⁷O NMR spectroscopy, preferably according to Reference Example 1.3;
wherein the catalyst is selected by calculating an activation factor (A) in accordance with formula I for each of the catalysts, and selecting a catalyst displaying an activation factor in the range of from 15 to 80 mmol/mol, wherein the activation factor is the multiplication product of the water adsorption and the concentration of bridging μ² η²-peroxo species per Ti in the H₂O₂-activated catalyst:

$$A = W \times C . \qquad ( I )$$

In case where providing the catalyst in (a) comprises selecting the catalyst among catalysts comprising Ti, Si, and O, it is preferred that providing the catalyst in (a) comprises selecting the catalyst among catalysts displaying a water adsorption in the range of from 1 to 10 wt.-%, preferably from 1.5 to 9.5 wt.-%, more preferably from 2 to 9 wt.-%, more preferably from 2.5 to 8.5 wt.-%, more preferably from 3 to 8 wt.-%, more preferably from 3.2 to 7.9 wt.-%, more preferably from 3.5 to 7.5 wt.-%, more preferably from 4 to 7 wt.-%, more preferably from 4.5 to 6.5 wt.-%, and more preferably from 5 to 6 wt.-%. Furthermore and independently thereof, it is preferred that providing the catalyst in (a) comprises selecting the catalyst among catalysts displaying a concentration of bridging μ² η²-peroxo species per Ti in the H₂O₂-activated catalyst in the range of from 200 to 1,200 mmol/mol, more preferably from 300 to 1,000 mmol/mol, more preferably from 350 to 950 mmol/mol, more preferably from 400 to 900 mmol/mol, more preferably from 450 to 850 mmol/mol, more preferably from 500 to 800 mmol/mol, more preferably from 550 to 750 mmol/mol, and more preferably from 600 to 700 mmol/mol. Furthermore and independently thereof, it is preferred that the catalyst is selected by calculating an activation factor (A) for each of the catalysts, and selecting a catalyst displaying an activation factor in the range of from 16 to 70, more preferably from 18 to 60 mmol/mol, more preferably from 20 to 55 mmol/mol, more preferably from 23 to 50 mmol/mol, more preferably from 25 to 45 mmol/mol, more preferably from 26 to 44 mmol/mol, more preferably from 27 to 42 mmol/mol, more preferably from 28 to 40 mmol/mol, more preferably from 29 to 37 mmol/mol, and more preferably from 30 to 35 mmol/mol. Furthermore and independently thereof, it is preferred that the concentration (C) of bridging μ² η²-peroxo species per Ti in the H₂O₂-activated catalyst as determined by quantitative ¹⁷O NMR spectroscopy is the concentration which is determined at a time point T after having brought the catalyst into contact with H₂¹⁷O₂, wherein T is in the range of from 1 to 720 min after having brought the catalyst into contact with H₂¹⁷O₂, more preferably from 2 min to 480 min, more preferably from 4 to 240 min, more preferably from 6 to 120 min, more preferably from 8 to 60 min, more preferably from 10 to 30 min, more preferably from 12 to 20 min, and more preferably from 14 to 16 min, wherein more preferably T is 15 min.

Alternatively, it is preferred that providing the catalyst in (a) comprises selecting the catalyst among catalysts displaying a concentration (C) of bridging μ² η²-peroxo species per Ti in the H₂O₂-activated catalyst as determined by quantitative ¹⁷O NMR spectroscopy in the range of from 200 to 825 mmol/mol, wherein the concentration (C) of bridging μ² η²-peroxo species per Ti in the H₂O₂-activated catalyst as determined by quantitative ¹⁷O NMR spectroscopy is the concentration which is determined at a time point T after having brought the catalyst into contact with H₂¹⁷O₂, wherein T is in the range of from 65 to 175 min. Further and independently thereof, it is preferred that providing the catalyst in (a) comprises selecting the catalyst among catalysts displaying a water adsorption in the range of from 1 to 7.9 wt.-%, more preferably from 3 to 7.5 wt.-%, more preferably from 4 to 7 wt.-%, more preferably from 4.5 to 6.5 wt.-%, and more preferably from 5 to 6 wt.-%. Further and independently thereof, it is preferred that providing the catalyst in (a) comprises selecting the catalyst among catalysts displaying a concentration (C) of bridging μ² η²-peroxo species per Ti in the H₂O₂-activated catalyst as determined by quantitative ¹⁷O NMR spectroscopy, more preferably determined according to Reference Example 1.3, in the range of from 300 to 822 mmol/mol, more preferably from 350 to 800 mmol/mol, more preferably from 400 to 780 mmol/mol, more preferably from 450 to 760 mmol/mol, more preferably from 500 to 740 mmol/mol, more preferably from 550 to 720 mmol/mol, and more preferably from 600 to 700 mmol/mol. Further and independently thereof, it is preferred that T is in the range of from 75 to 165 min, more preferably from 85 min to 155 min, more preferably from 95 to 145 min, more preferably from 105 to 135 min, more preferably from 112 to 128 min, more preferably from 116 to 124 min, more preferably from 118 to 122 min, and more preferably from 119 to 121 min, wherein more preferably T is 120 min. Further and independently thereof, it is preferred that the activation factor (A) is in the range of from 16 to 75 mmol/mol, more preferably from 18 to 67 mmol/mol, more preferably from 20 to 65 mmol/mol, more preferably from 22 to 60 mmol/mol, more preferably from 24 to 55 mmol/mol, more preferably from 26 to 50 mmol/mol, more preferably from 27 to 45 mmol/mol, more preferably from 28 to 40 mmol/mol, more preferably from 29 to 37 mmol/mol, and more preferably from 30 to 34 mmol/mol.

It is preferred that providing the catalyst in (a) comprises selecting the catalyst among catalysts comprising from 0 to 1 weight-%, more preferably from 0 to 0.1 weight-%, more preferably from 0 to 0.01 weight-%, more preferably from 0 to 0.001 weight-%, of B, calculated as the element and based on the total weight of the catalyst.

It is preferred that providing the catalyst in (a) comprises selecting the catalyst among catalysts comprising from 0 to 1 weight-%, more preferably from 0 to 0.1 weight-%, more preferably from 0 to 0.01 weight-%, more preferably from 0 to 0.001 weight-%, of Na, calculated as the element and based on the total weight of the catalyst.

It is preferred that providing the catalyst in (a) comprises selecting the catalyst among catalysts comprising from 0 to 1 weight-%, more preferably from 0 to 0.1 weight-%, more preferably from 0 to 0.01 weight-%, more preferably from 0 to 0.001 weight-%, of Ge, calculated as the element and based on the total weight of the catalyst.

It is preferred that providing the catalyst in (a) comprises selecting the catalyst among catalysts comprising from 0 to 1 weight-%, more preferably from 0 to 0.5 weight-%, more preferably from 0 to 0.2 weight-%, more preferably from 0 to 0.1 weight-%, of C, calculated as the element and based on the total weight of the catalyst.

It is preferred that providing the catalyst in (a) comprises selecting the catalyst among catalysts exhibiting a propylene oxide activity of at least 2.0 weight-%, more preferably in the range of from 3.0 to 15.0 weight-%, more preferably in the range of from 9.0 to 13.0 weight-%, more preferably determined as described in Reference Example 1.6.

It is preferred that the one or more binders in (b) are selected from the group consisting of inorganic binders, wherein the one or more binders more preferably comprise one or more sources of a metal oxide and/or of a metalloid oxide, more preferably one or more sources of a metal oxide and/or of a metalloid oxide selected from the group consisting of silica, alumina, titania, zirconia, lanthana, magnesia, and mixtures and/or mixed oxides of two or more thereof, more preferably from the group consisting of silica, alumina, titania, zirconia, magnesia, silica-alumina mixed oxides, silica-titania mixed oxides, silica-zirconia mixed oxides, silica-lanthana mixed oxides, silica-zirconia-lanthana mixed oxides, alumina-titania mixed oxides, alumina-zirconia mixed oxides, alumina-lanthana mixed oxides, alumina-zirconia-lanthana mixed oxides, titania-zirconia mixed oxides, and mixtures and/or mixed oxides of two or more thereof, more preferably from the group consisting of silica, alumina, silica-alumina mixed oxides, and mixtures of two or more thereof, wherein more preferably the one or more binders in (b) comprise one or more sources of silica, wherein more preferably the one or more binders in (b) consist of one or more sources of silica, wherein the one or more sources of silica preferably comprise one or more compounds selected from the group consisting of fumed silica, colloidal silica, silica-alumina, colloidal silica-alumina, and mixtures of two or more thereof, more preferably one or more compounds selected from the group consisting of fumed silica, colloidal silica, and mixtures thereof, wherein more preferably the one or more binders in (b) consist of colloidal silica.

It is preferred that step (b) further comprises mixing the zeolitic material and the one or more binders with a solvent system, wherein the solvent system comprises one or more solvents, wherein more preferably the solvent system comprises one or more hydrophilic solvents, the hydrophilic solvents preferably being selected from the group consisting of polar solvents, more preferably from the group consisting of polar protic solvents, wherein more preferably the solvent system comprises one or more polar protic solvents selected from the group consisting of water, alcohols, carboxylic acids, and mixtures of two or more thereof, more preferably from the group consisting of water, C1-C5 alcohols, C1-C5 carboxylic acids, and mixtures of two or more thereof, more preferably from the group consisting of water, C1-C4 alcohols, C1-C4 carboxylic acids, and mixtures of two or more thereof, more preferably from the group consisting of water, C1-C3 alcohols, C1-C3 carboxylic acids, and mixtures of two or more thereof, more preferably from the group consisting of water, methanol, ethanol, propanol, formic acid, acetic acid, and mixtures of two or more thereof, more preferably from the group consisting of water, ethanol, acetic acid, and mixtures of two or more thereof, wherein more preferably the solvent system comprises water and/or ethanol, and wherein more preferably the solvent system comprises water, wherein even more preferably the solvent system consists of water.

It is preferred that step (b) further comprises mixing the zeolitic material and the one or more binders with one or more pore forming agents and/or lubricants and/or plasticizers, wherein the one or more pore forming agents and/or lubricants and/or plasticizers are more preferably selected from the group consisting of polymers, carbohydrates, graphite, plant additives, and mixtures of two or more thereof, more preferably from the group consisting of polymeric vinyl compounds, polyalkylene oxides, polyacrylates, polyolefins, polyamides, polyesters, cellulose and cellulose derivatives, sugars, sesbania cannabina, and mixtures of two or more thereof, more preferably from the group consisting of polystyrene, C2-C3 polyalkylene oxides, cellulose derivatives, sugars, and mixtures of two or more thereof, more preferably from the group consisting of polystyrene, polyethylene oxide, C1-C2 hydroxyalkylated and/or C1-C2 alkylated cellulose derivatives, sugars, and mixtures of two or more thereof, more preferably from the group consisting of polystyrene, polyethylene oxide, hydroxyethyl methyl cellulose, and mixtures of two or more thereof, wherein more preferably the one or more pore forming agents and/or lubricants and/or plasticizers consists of one or more selected from the group consisting of polystyrene, polyethylene oxide, hydroxyethyl methyl cellulose, and mixtures of two or more thereof, and more preferably wherein the one or more pore forming agents and/or lubricants and/or plasticizers consist of a mixture of polystyrene, polyethylene oxide, and hydroxyethyl methyl cellulose.

It is preferred that the calcining of the dried molding obtained in step (e) is performed at a temperature ranging from 350 to 850° C., more preferably from 400 to 700° C., more preferably from 450 to 650° C., and more preferably from 475 to 600° C.

The present invention also relates to a catalyst molding comprising a catalyst for hydrogen peroxide activation according to any one of the particular and preferred embodiments of the present invention, wherein the catalyst molding is preferably obtainable or obtained by a process according to any one of the particular and preferred embodiments of the present invention.

The present invention also relates to a process for the activation of hydrogen peroxide comprising:
(1) providing a reactor comprising a catalyst for hydrogen peroxide activation according to any of the particular and preferred embodiments of the present invention, or a catalyst molding according to any of the particular and preferred embodiments of the present invention;
(2) contacting the catalyst or catalyst molding provided in (1) with hydrogen peroxide.

It is preferred that providing the catalyst in (1) comprises selecting the catalyst among catalysts comprising Ti, Si, and O, and displaying
a water adsorption (W), preferably determined according to Reference Example 1.1, and
a concentration (C) of bridging μ² η²-peroxo species per Ti in the H₂O₂-activated catalyst as determined by quantitative ¹⁷O NMR spectroscopy, preferably according to Reference Example 1.3;
wherein the catalyst is selected by calculating an activation factor (A) in accordance with formula I for each of the catalysts, and selecting a catalyst displaying an activation factor in the range of from 15 to 80 mmol/mol, wherein the activation factor is the multiplication product of the water adsorption and the concentration of bridging μ² η²-peroxo species per Ti in the H₂O₂-activated catalyst:

$$A = W \times C . \qquad ( I )$$

In case where providing the catalyst in (1) comprises selecting the catalyst among catalysts comprising Ti, Si, and O, wherein the catalyst is selected by calculating an activation factor (A) in accordance with formula I for each of the catalysts, it is preferred that providing the catalyst in (1) comprises selecting the catalyst among catalysts displaying a water adsorption in the range of from 1 to 10 wt.-%, more preferably from 1.5 to 9.5 wt.-%, more preferably from 2 to 9 wt.-%, more preferably from 2.5 to 8.5 wt.-%, more preferably from 3 to 8 wt.-%, more preferably from 3.2 to 7.9 wt.-%, more preferably from 3.5 to 7.5 wt.- %, more preferably from 4 to 7 wt.-%, more preferably from 4.5 to 6.5 wt.-%, and more preferably from 5 to 6 wt.-%. Further and independently thereof, in case where providing the catalyst in (1) comprises selecting the catalyst among catalysts comprising Ti, Si, and O, wherein the catalyst is selected by calculating an activation factor (A) in accordance with formula I for each of the catalysts, it is preferred that providing the catalyst in (1) comprises selecting the catalyst among catalysts displaying a concentration of bridging μ² η²-peroxo species per Ti in the H₂O₂-activated catalyst in the range of from 200 to 1,200 mmol/mol, more preferably from 300 to 1,000 mmol/mol, more preferably from 350 to 950 mmol/mol, more preferably from 400 to 900 mmol/mol, more preferably from 450 to 850 mmol/mol, more preferably from 500 to 800 mmol/mol, more preferably from 550 to 750 mmol/mol, and more preferably from 600 to 700 mmol/mol. Furthermore and independently thereof, in case where providing the catalyst in (a) comprises selecting the catalyst among catalysts comprising Ti, Si, and O, wherein the catalyst is selected by calculating an activation factor (A) in accordance with formula I for each of the catalysts, it is preferred that the catalyst is selected by calculating an activation factor (A) for each of the catalysts, and selecting a catalyst displaying an activation factor in the range of from 16 to 70 mmol/mol, more preferably from 18 to 60 mmol/mol, more preferably from 20 to 55 mmol/mol, more preferably from 23 to 50 mmol/mol, more preferably from 25 to 45 mmol/mol, more preferably from 26 to 44 mmol/mol, more preferably from 27 to 42 mmol/mol, more preferably from 28 to 40 mmol/mol, more preferably from 29 to 37 mmol/mol, and more preferably from 30 to 35 mmol/mol.

Furthermore and independently thereof, in case where providing the catalyst in (a) comprises selecting the catalyst among catalysts comprising Ti, Si, and O, wherein the catalyst is selected by calculating an activation factor (A) in accordance with formula I for each of the catalysts, it is preferred that the concentration (C) of bridging μ² η²-peroxo species per Ti in the H₂O₂-activated catalyst as determined by quantitative ¹⁷O NMR spectroscopy is the concentration which is determined at a time point T after having brought the catalyst into contact with H₂¹⁷O₂, wherein T is in the range of from 1 to 720 min after having brought the catalyst into contact with H₂¹⁷O₂, more preferably from 2 min to 480 min, more preferably from 4 to 240 min, more preferably from 6 to 120 min, more preferably from 8 to 60 min, more preferably from 10 to 30 min, more preferably from 12 to 20 min, and more preferably from 14 to 16 min, wherein more preferably T is 15 min.

Alternatively, in case where providing the catalyst in (1) comprises selecting the catalyst among catalysts comprising Ti, Si, and O, wherein the catalyst is selected by calculating an activation factor (A) in accordance with formula I for each of the catalysts, it is preferred that providing the catalyst in (1) comprises selecting the catalyst among catalysts displaying a concentration (C) of bridging μ² η²-peroxo species per Ti in the H₂O₂-activated catalyst as determined by quantitative ¹⁷O NMR spectroscopy in the range of from 200 to 825 mmol/mol, wherein the concentration (C) of bridging μ² η²-peroxo species per Ti in the H₂O₂-activated catalyst as determined by quantitative ¹⁷O NMR spectroscopy is the concentration which is determined at a time point T after having brought the catalyst into contact with H₂¹⁷O₂, wherein T is in the range of from 65 to 175 min. Further and independently thereof, in the case where providing the catalyst in (1) comprises selecting the catalyst among catalysts comprising Ti, Si, and O, wherein the catalyst is selected by calculating an activation factor (A) in accordance with formula I for each of the catalysts, it is preferred that providing the catalyst in (1) comprises selecting the catalyst among catalysts displaying a water adsorption in the range of from 1 to 7.9 wt.-%, more preferably from 3 to 7.5 wt.-%, more preferably from 4 to 7 wt.-%, more preferably from 4.5 to 6.5 wt.-%, and more preferably from 5 to 6 wt.-%. Further and independently thereof, in the case where providing the catalyst in (1) comprises selecting the catalyst among catalysts comprising Ti, Si, and O, wherein the catalyst is selected by calculating an activation factor (A) in accordance with formula I for each of the catalysts, it is preferred that providing the catalyst in (1) comprises selecting the catalyst among catalysts displaying a concentration (C) of bridging μ² η²-peroxo species per Ti in the H₂O₂-activated catalyst as determined by quantitative ¹⁷O NMR spectroscopy, preferably determined according to Reference Example 1.3, in the range of from 300 to 822 mmol/mol, more preferably from 350 to 800 mmol/mol, more preferably from 400 to 780 mmol/mol, more preferably from 450 to 760 mmol/mol, more preferably from 500 to 740 mmol/mol, more preferably from 550 to 720 mmol/mol, and more preferably from 600 to 700 mmol/mol. Further and independently thereof, in the case where providing the catalyst in (1) comprises selecting the catalyst among catalysts comprising Ti, Si, and O, wherein the catalyst is selected by calculating an activation factor (A) in accordance with formula I for each of the catalysts, it is preferred according to the second alternative that T is in the range of from 75 to 165 min, more preferably from 85 min to 155 min, more preferably from 95 to 145 min, more preferably from 105 to 135 min, more preferably from 112 to 128 min, more preferably from 116 to 124 min, more preferably from 118 to 122 min, and more preferably from 119 to 121 min, wherein more preferably T is 120 min. Further and independently thereof, in the case where providing the catalyst in (1) comprises selecting the catalyst among catalysts comprising Ti, Si, and O, wherein the catalyst is selected by calculating an activation factor (A) in accordance with formula I for each of the catalysts, it is preferred that the activation factor (A) is in the range of from 16 to 75 mmol/mol, more preferably from 18 to 67 mmol/mol, more preferably from 20 to 65 mmol/mol, more preferably from 22 to 60 mmol/mol, more preferably from 24 to 55 mmol/mol, more preferably from 26 to 50 mmol/mol, more preferably from 27 to 45 mmol/mol, more preferably from 28 to 40 mmol/mol, more preferably from 29 to 37 mmol/mol, and more preferably from 30 to 34 mmol/mol.

It is preferred that providing the catalyst in (1) comprises selecting the catalyst among catalysts comprising from 0 to 1 weight-%, more preferably from 0 to 0.1 weight-%, more preferably from 0 to 0.01 weight-%, more preferably from 0 to 0.001 weight-%, of B, calculated as the element and based on the total weight of the catalyst.

It is preferred that providing the catalyst in (1) comprises selecting the catalyst among catalysts comprising from 0 to 1 weight-%, more preferably from 0 to 0.1 weight-%, more preferably from 0 to 0.01 weight-%, more preferably from 0 to 0.001 weight-%, of Na, calculated as the element and based on the total weight of the catalyst.

It is preferred that providing the catalyst in (1) comprises selecting the catalyst among catalysts comprising from 0 to 1 weight-%, more preferably from 0 to 0.1 weight-%, more preferably from 0 to 0.01 weight-%, more preferably from 0 to 0.001 weight-%, of Ge, calculated as the element and based on the total weight of the catalyst.

It is preferred that providing the catalyst in (1) comprises selecting the catalyst among catalysts comprising from 0 to 1 weight-%, preferably from 0 to 0.5 weight-%, more preferably from 0 to 0.2 weight-%, more preferably from 0 to 0.1 weight-%, of C, calculated as the element and based on the total weight of the catalyst.

It is preferred that providing the catalyst in (1) comprises selecting the catalyst among catalysts exhibiting a propylene oxide activity of at least 2.0 weight-%, more preferably in the range of from 3.0 to 15.0 weight-%, more preferably in the range of from 9.0 to 13.0 weight-%, preferably determined as described in Reference Example 1.6.

It is preferred that in (2) hydrogen peroxide is comprised in a liquid feed stream which is fed into the reactor, wherein the liquid feed stream further comprises one or more unsaturated organic compounds, more preferably with one or more olefins, more preferably with one or more C2-C5 alkenes, more preferably with one or more C2-C4 alkenes, more preferably with one or more C2 or C3 alkenes, more preferably propylene.

In case where in (2) hydrogen peroxide is comprised in a liquid feed stream which is fed into the reactor, wherein the liquid feed stream further comprises one or more unsaturated organic compounds, it is preferred that the liquid feed stream further comprises a solvent system, wherein the solvent system comprises one or more solvents, wherein more preferably the solvent system comprises one or more hydrophilic solvents, the hydrophilic solvents more preferably being selected from the group consisting of polar solvents, more preferably from the group consisting of polar protic solvents, wherein more preferably the solvent system comprises one or more polar protic solvents selected from the group consisting of water, alcohols, and mixtures of two or more thereof, more preferably from the group consisting of water, C1-C5 alcohols, and mixtures of two or more thereof, more preferably from the group consisting of water, C1-C4 alcohols, and mixtures of two or more thereof, more preferably from the group consisting of water, C1-C3 alcohols, and mixtures of two or more thereof, more preferably from the group consisting of water, methanol, ethanol, propanol, and mixtures of two or more thereof, more preferably from the group consisting of water, methanol, and mixtures thereof, wherein more preferably the solvent system comprises water, preferably water and methanol, wherein more preferably the solvent system consists of water and methanol.

Furthermore and independently thereof, it is preferred that the liquid feed stream comprises hydrogen peroxide at a concentration in the range of from 1 to 75 weight-%, more preferably from 3 to 50 weight-%, 5 to 30 weight-%, more preferably from 7 to 25 weight-%, more preferably from 8 to 20 weight-%, more preferably from 9 to 15 weight-%, more preferably from 10 to 12 weight-%, based on the total weight of the liquid feed stream.

Furthermore and independently thereof, it is preferred that the liquid feed stream fed into the reactor in (2) has a temperature in the range of from 0 to 60° C., more preferably from 25 to 50° C.

Furthermore and independently thereof, it is preferred that the liquid feed stream fed into the reactor in (2) is at a pressure in the range of from 5 to 100 bar, more preferably from 10 to 50 bar, more preferably from 15 to 25 bar.

Furthermore and independently thereof, it is preferred that contacting in (2) is conducted at a temperature in the range of from 10 to 100° C., more preferably from 25 to 80° C., more preferably from 30 to 75° C., more preferably from 40 to 65° C.

Furthermore and independently thereof, it is preferred that contacting in (2) is conducted at a pressure in the range of from 5 to 100 bar, more preferably from 10 to 50 bar, more preferably from 14 to 32 bar, more preferably from 15 to 25 bar, wherein the pressure is defined as the pressure at the exit of the reactor.

Furthermore and independently thereof, it is preferred that the catalyst loading in the reactor in (1) is in the range of from 0.05 to 5 h⁻¹, more preferably from 0.1 to 4 h⁻¹, more preferably from 0.2 to 3.5 h⁻¹, more preferably from 0.7 to 3 h⁻¹, more preferably from 1 to 2.75 h⁻¹, more preferably from 1.25 to 2.5 h⁻¹, more preferably from 1.5 to 2.25 h⁻¹, more preferably from 1.75 to 2 h⁻¹, wherein the catalyst loading is defined as the ratio of the mass flow rate in kg/h of hydrogen peroxide contained in the liquid feed stream divided by the amount in kg of the catalyst comprised in the reactor in (1).

Furthermore and independently thereof, it is preferred that the process further comprises (3) removing an effluent stream from the reactor, the effluent stream comprising an oxidized organic compound, and preferably comprising an epoxidized organic compound, more preferably an alkylene oxide, more preferably an alkylene oxide selected from C2-C5 alkylene oxides, more preferably from C2-C4 alkylene oxides, more preferably from C2 or C3 alkylene oxides, more preferably from C3 alkylene oxides, wherein more preferably the effluent stream comprises propylene oxide.

The present invention also relates to the use of the catalyst according to any one of the particular and preferred embodiments of the present invention, or of a catalyst molding according any one of the particular and preferred embodiments of the present invention, as a catalyst and/or catalyst component in a reaction involving C—C bond formation and/or conversion, and preferably as a catalyst and/or catalyst component in an isomerization reaction, in an ammoximation reaction, in an amination reaction, in a hydrocracking reaction, in an alkylation reaction, in an acylation reaction, in a reaction for the conversion of alkanes to olefins, or in a reaction for the conversion of one or more oxygenates to olefins and/or aromatics, in a reaction for the synthesis of hydrogen peroxide, in an aldol condensation reaction, in a reaction for the isomerization of epoxides, in a transesterification reaction, in a hydroxylation reaction, in a Baeyer-Villiger-type oxidation reaction, in a Dakin-type reaction, or in an epoxidation reaction, preferably as a catalyst and/or catalyst component in a hydroxylation reaction, in a Baeyer-Villiger-type oxidation reaction, in a Dakin-type reaction, or in a reaction for the epoxidation of olefins, more preferably in a reaction for the epoxidation of olefins, more preferably in a reaction for the epoxidation of C2-C5 alkenes, more preferably in a reaction for the epoxidation of C2-C4 alkenes, in a reaction for the epoxidation of C2 or C3 alkenes, more preferably for the epoxidation of C3 alkenes, and more preferably as a catalyst or catalyst component for the conversion of propylene to propylene oxide.

The present invention is further illustrated by the following set of embodiments and combinations of embodiments resulting from the dependencies and back-references as indicated. In particular, it is noted that in each instance where a range of embodiments is mentioned, for example in the context of a term such as “The catalyst of any one of embodiments 1 to 4”, every embodiment in this range is meant to be explicitly disclosed for the skilled person, i.e. the wording of this term is to be understood by the skilled person as being synonymous to “The catalyst of any one of embodiments 1, 2, 3, and 4”. Further, it is explicitly noted that the following set of embodiments is not the set of claims determining the extent of protection, but represents a suitably structured part of the description directed to general and preferred aspects of the present invention. Further, it was found that a process for the preparation of such an improved catalyst can be provided. In addition, it was found that a process for the activation of hydrogen peroxide can be provided, wherein a specific catalyst is used.
1. A catalyst for hydrogen peroxide activation, wherein the catalyst comprises Ti, Si, and O, wherein the catalyst displays a water adsorption (W), preferably determined according to Reference Example 1.1, a concentration (C) of bridging μ² η²-peroxo species per Ti in the H₂O₂-activated catalyst as determined by quantitative ¹⁷O NMR spectroscopy, preferably determined according to Reference Example 1.3, and an activation factor (A) according to formula I, wherein the activation factor is in the range of from 15 to 80 mmol/mol;
   wherein in accordance with formula I, the activation factor is the multiplication product of the water adsorption and the concentration of bridging μ² η²-peroxo species per Ti in the H₂O₂-activated catalyst:

$$A = W \times C . \qquad ( I )$$

2. The catalyst of embodiment 1, wherein the catalyst displays a water adsorption in the range of from 1 to 10 wt.-%, preferably from 1.5 to 9.5 wt.-%, more preferably from 2 to 9 wt.-%, more preferably from 2.5 to 8.5 wt.-%, more preferably from 3 to 8 wt.-%, more preferably from 3.2 to 7.9 wt.-%, more preferably from 3.5 to 7.5 wt.-%, more preferably from 4 to 7 wt.-%, more preferably from 4.5 to 6.5 wt.-%, and more preferably from 5 to 6 wt.-%.
3. The catalyst of embodiment 1 or 2, wherein the catalyst displays a concentration of bridging μ² η²-peroxo species per Ti in the H₂O₂-activated catalyst in the range of from 200 to 1,200 mmol/mol, preferably from 300 to 1,000 mmol/mol, more preferably from 350 to 950 mmol/mol, more preferably from 400 to 900 mmol/mol, more preferably from 450 to 850 mmol/mol, more preferably from 500 to 800 mmol/mol, more preferably from 550 to 750 mmol/mol, and more preferably from 600 to 700 mmol/mol.
4. The catalyst of any one of embodiments 1 to 3, wherein the concentration (C) of bridging μ² η²-peroxo species per Ti in the H₂O₂-activated catalyst as determined by quantitative ¹⁷O NMR spectroscopy is the concentration which is determined at a time point T after having brought the catalyst into contact with H₂¹⁷O₂, wherein T is in the range of from 1 to 720 min after having brought the catalyst into contact with H₂¹⁷O₂, preferably from 2 min to 480 min, more preferably from 4 to 240 min, more preferably from 6 to 120 min, more preferably from 8 to 60 min, more preferably from 10 to 30 min, more preferably from 12 to 20 min, and more preferably from 14 to 16 min, wherein more preferably T is 15 min.
5. The catalyst of any one of embodiments 1 to 4, wherein the activation factor is in the range of from 16 to 70 mmol/mol, preferably from 18 to 60 mmol/mol, more preferably from 20 to 55 mmol/mol, more preferably from 23 to 50 mmol/mol, more preferably from 25 to 45 mmol/mol, more preferably from 26 to 44 mmol/mol, more preferably from 27 to 42 mmol/mol, more preferably from 28 to 40 mmol/mol, more preferably from 29 to 37 mmol/mol, and more preferably from 30 to 35 mmol/mol.
6. The catalyst of embodiment 1, wherein the catalyst displays a concentration of bridging μ² η²-peroxo species per Ti in the H₂O₂-activated catalyst in the range of from 200 to 825 mmol/mol, wherein the concentration of bridging μ² η²-peroxo species per Ti in the H₂O₂-activated catalyst as determined by quantitative ¹⁷O NMR spectroscopy is the concentration which is determined at a time point T after having brought the catalyst into contact with H₂¹⁷O₂, wherein T is in the range of from 65 to 175 min.
7. The catalyst of embodiment 6, wherein the catalyst displays a water adsorption in the range of from 1 to 7.9 wt.-%, preferably from 3 to 7.5 wt.-%, more preferably from 4 to 7 wt.-%, more preferably from 4.5 to 6.5 wt.-%, and more preferably from 5 to 6 wt.-%.
8. The catalyst of embodiment 6 or 7, wherein the catalyst displays a concentration of bridging μ² η²-peroxo species per Ti in the H₂O₂-activated catalyst as determined by quantitative ¹⁷O NMR spectroscopy, preferably determined according to Reference Example 1.3, in the range of from 300 to 822 mmol/mol, preferably from 350 to 800 mmol/mol, more preferably from 400 to 780 mmol/mol, more preferably from 450 to 760 mmol/mol, more preferably from 500 to 740 mmol/mol, more preferably from 550 to 720 mmol/mol, and more preferably from 600 to 700 mmol/mol.
9. The catalyst of any one of embodiments 6 to 8, wherein T is in the range of from 75 to 165 min, preferably from 85 min to 155 min, more preferably from 95 to 145 min, more preferably from 105 to 135 min, more preferably from 112 to 128 min, more preferably from 116 to 124 min, more preferably from 118 to 122 min, and more preferably from 119 to 121 min, wherein more preferably T is 120 min.
10. The catalyst of any one of embodiments 6 to 9, wherein the activation factor is in the range of from 16 to 75 mmol/mol, preferably from 18 to 67 mmol/mol, more preferably from 20 to 65 mmol/mol, more preferably from 22 to 60 mmol/mol, more preferably from 24 to 55 mmol/mol, more preferably from 26 to 50 mmol/mol, more preferably from 27 to 45 mmol/mol, more preferably from 28 to 40 mmol/mol, more preferably from 29 to 37 mmol/mol, and more preferably from 30 to 34 mmol/mol.
11. The catalyst of any one of embodiments 1 to 10, wherein the catalyst displays a XANES spectrum having a ratio of the intensity of the signal at 4987 eV to the intensity of the signal at 4992 eV in the range of from 0.95:1 to 1.07:1, preferably of from 0.97:1 to 1.07:1, more preferably in the range of from 0.99:1 to 1.07:1, more preferably in the range of from 1.01:1 to 1.07:1, more preferably in the range of from 1.03:1 to 1.07:1, and more preferably in the range of from 1.05:1 to 1.07:1, wherein the XANES spectrum is preferably determined according Reference Example 1.2.
12. The catalyst of any one of embodiments 1 to 11, having a BET specific surface area in the range of from 350 to 475 m²/g, preferably from 370 to 455 m²/g, more preferably from 390 to 435 m²/g, wherein the BET specific surface area is preferably determined according to Reference Example 1.5.
13. The catalyst of any one of embodiments 1 to 12, comprising from 0.5 to 2.5 weight-%, preferably from 0.8 to 2.0 weight-%, more preferably from 1.0 to 1.9 weight-%, more preferably from 1.0 to 1.8 weight-%, more preferably from 1.1 to 1.3 weight-%, of Ti, calculated as the element and based on the total weight of the catalyst.
14. The catalyst of any one of embodiments 1 to 13, comprising from 0 to 1 weight-%, preferably from 0 to 0.1 weight-%, more preferably from 0 to 0.01 weight-%, more preferably from 0 to 0.001 weight-%, of B, calculated as the element and based on the total weight of the catalyst.
15. The catalyst of any one of embodiments 1 to 14, comprising from 0 to 1 weight-%, preferably from 0 to 0.1 weight-%, more preferably from 0 to 0.01 weight-%, more preferably from 0 to 0.001 weight-%, of Na, calculated as the element and based on the total weight of the catalyst.
16 The catalyst of any one of embodiments 1 to 15, comprising from 0 to 1 weight-%, preferably from 0 to 0.1 weight-%, more preferably from 0 to 0.01 weight-%, more preferably from 0 to 0.001 weight-%, of Ge, calculated as the element and based on the total weight of the catalyst.
17. The catalyst of any one of embodiments 1 to 16, comprising from 0 to 1 weight-%, preferably from 0 to 0.5 weight-%, more preferably from 0 to 0.2 weight-%, more preferably from 0 to 0.1 weight-%, of C, calculated as the element and based on the total weight of the catalyst.
18. The catalyst of any one of embodiments 1 to 17, exhibiting a propylene oxide activity of at least 2.0 weight-%, preferably in the range of from 3.0 to 15.0 weight-%, more preferably in the range of from 9.0 to 13.0 weight-%, preferably determined as described in Reference Example 1.6.
19. The catalyst of any one of embodiments 1 to 18, wherein the catalyst further comprises one or more metals selected from the group consisting of Zn, Cd, Sn, La, and Ba, including mixtures of two or more thereof.
20. The catalyst of any one of embodiments 1 to 19, wherein from 95 to 100 wt.-% of the catalyst consists of Ti, Si, and O, preferably from 97 to 100 wt.-%, more preferably from 98 to 100 wt.-%, more preferably from 99 to 100 wt.-%, more preferably from 99.5 to 100 wt.-%, and more preferably from 99.9 to 100 wt.-%.
21. The catalyst of any one of embodiments 1 to 20, wherein from 95 to 100 wt.-% of the catalyst consists of Ti, Si, O, and H, preferably from 97 to 100 wt.-%, more preferably from 98 to 100 wt.-%, more preferably from 99 to 100 wt.-%, more preferably from 99.5 to 100 wt.-%, and more preferably from 99.9 to 100 wt.-%.
22. The catalyst of any one of embodiments 1 to 21, wherein the catalyst comprises, preferably consists of, a zeolitic material having a framework structure comprising Si, Ti, and O.
23. The catalyst of embodiment 22, the zeolitic material having an Si:Ti molar ratio in the range of from 1 to 250, preferably in the range of from 10 to 150, more preferably in the range of from 20 to 95, more preferably in the range of from 30 to 75, more preferably in the range of from 35 to 70, more preferably in the range of from 40 to 65, more preferably in the range of from 45 to 60, more preferably in the range of from 50 to 55.
24. The catalyst of embodiment 22 or 23, wherein the zeolitic material has a framework structure type selected from the group consisting of MFI, MEL, MWW, ITH, IWR, IMF, SVY, FER, SVR, and intergrowth structures of two or more thereof, preferably selected from the group consisting of MFI, MEL, MWW, ITH, and IWR, and intergrowth structures of two or more thereof, more preferably selected from the group consisting of MFI, MEL, and intergrowth structures thereof, wherein the zeolitic material more preferably has an MFI-type framework structure.
25. The catalyst of any one of embodiments 22 to 24, wherein the zeolitic material is a TS1 zeolite.
26. The catalyst of any one of embodiments 22 to 25, wherein the zeolitic material further comprises one or more metals selected from the group consisting of Zn, Cd, Sn, La, and Ba, including mixtures of two or more thereof, wherein the one or more metals are preferably contained in the pores of the zeolitic material.
27. The catalyst of any one of embodiments 22 to 26, wherein from 95 to 100 wt.-% of the zeolitic material consists of Ti, Si, and O, preferably from 97 to 100 wt.-%, more preferably from 98 to 100 wt.-%, more preferably from 99 to 100 wt.-%, more preferably from 99.5 to 100 wt.-%, and more preferably from 99.9 to 100 wt.-%.
28. The catalyst of any one of embodiments 22 to 27, wherein from 95 to 100 wt.-% of the zeolitic material consists of Ti, Si, O, and H, preferably from 97 to 100 wt.-%, more preferably from 98 to 100 wt.-%, more preferably from 99 to 100 wt.-%, more preferably from 99.5 to 100 wt.-%, and more preferably from 99.9 to 100 wt.-%.
29. The catalyst of any one of embodiments 22 to 28, wherein the zeolitic material has a crystallinity in the range of from 50 to 100 weight-%, preferably from 75 to 100 weight-%, more preferably from 80 to 100 weight-%, and more preferably from 90 to 100 weight-%, wherein the crystallinity is preferably determined as described in Reference Example 1.4.
30. A method for the preparation of a catalyst molding, comprising
   (a) providing a catalyst for hydrogen peroxide activation according to any of embodiments 1 to 29;
   (b) mixing the catalyst provided in step (a) with one or more binders;
   (c) optionally kneading of the mixture obtained in step (b);
   (d) molding of the mixture obtained in step (b) or (c) to obtain one or more moldings;
   (e) optionally drying of the one or more moldings obtained in step (d); and
   (f) calcining of the molding obtained in step (d) or (e).
31. The method of embodiment 30, wherein providing the catalyst in (a) comprises selecting the catalyst among catalysts comprising Ti, Si, and O, and displaying
   a water adsorption (W), preferably determined according to Reference Example 1.1, and
   a concentration (C) of bridging μ² η²-peroxo species per Ti in the H₂O₂-activated catalyst as determined by quantitative ¹⁷O NMR spectroscopy, preferably according to Reference Example 1.3;
   wherein the catalyst is selected by calculating an activation factor (A) in accordance with formula I for each of the catalysts, and selecting a catalyst displaying an activation factor in the range of from 15 to 80 mmol/mol, wherein the activation factor is the multiplication product of the water adsorption and the concentration of bridging μ² η²-peroxo species per Ti in the H₂O₂-activated catalyst:

$$A = W \times C . \qquad ( I )$$

32. The method of embodiment 30 or 31, wherein providing the catalyst in (a) comprises selecting the catalyst among catalysts displaying a water adsorption in the range of from 1 to 10 wt.-%, preferably from 1.5 to 9.5 wt.-%, more preferably from 2 to 9 wt.-%, more preferably from 2.5 to 8.5 wt.-%, more preferably from 3 to 8 wt.-%, more preferably from 3.2 to 7.9 wt.-%, more preferably from 3.5 to 7.5 wt.-%, more preferably from 4 to 7 wt.-%, more preferably from 4.5 to 6.5 wt.-%, and more preferably from 5 to 6 wt.-%.
33. The method of any one of embodiments 30 to 32, wherein providing the catalyst in (a) comprises selecting the catalyst among catalysts displaying a concentration of bridging μ² η²-peroxo species per Ti in the H₂O₂-activated catalyst in the range of from 200 to 1,200 mmol/mol, preferably from 300 to 1,000 mmol/mol, more preferably from 350 to 950 mmol/mol, more preferably from 400 to 900 mmol/mol, more preferably from 450 to 850 mmol/mol, more preferably from 500 to 800 mmol/mol, more preferably from 550 to 750 mmol/mol, and more preferably from 600 to 700 mmol/mol.
34. The method of any one of embodiments 30 to 33, wherein the catalyst is selected by calculating an activation factor (A) for each of the catalysts, and selecting a catalyst displaying an activation factor in the range of from 16 to 70, preferably from 18 to 60 mmol/mol, more preferably from 20 to 55 mmol/mol, more preferably from 23 to 50 mmol/mol, more preferably from 25 to 45 mmol/mol, more preferably from 26 to 44 mmol/mol, more preferably from 27 to 42 mmol/mol, more preferably from 28 to 40 mmol/mol, more preferably from 29 to 37 mmol/mol, and more preferably from 30 to 35 mmol/mol.
35. The method of any one of embodiments 30 to 34, wherein the concentration (C) of bridging μ² η²-peroxo species per Ti in the H₂O₂-activated catalyst as determined by quantitative ¹⁷O NMR spectroscopy is the concentration which is determined at a time point T after having brought the catalyst into contact with H₂¹⁷O₂, wherein T is in the range of from 1 to 720 min after having brought the catalyst into contact with H₂¹⁷O₂, preferably from 2 min to 480 min, more preferably from 4 to 240 min, more preferably from 6 to 120 min, more preferably from 8 to 60 min, more preferably from 10 to 30 min, more preferably from 12 to 20 min, and more preferably from 14 to 16 min, wherein more preferably T is 15 min.
36. The method of embodiment 31, wherein providing the catalyst in (a) comprises selecting the catalyst among catalysts displaying a concentration (C) of bridging μ² η²-peroxo species per Ti in the H₂O₂-activated catalyst as determined by quantitative 170 NMR spectroscopy in the range of from 200 to 825 mmol/mol, wherein the concentration (C) of bridging μ² η²-peroxo species per Ti in the H₂O₂-activated catalyst as determined by quantitative ¹⁷O NMR spectroscopy is the concentration which is determined at a time point T after having brought the catalyst into contact with H₂¹⁷O₂, wherein T is in the range of from 65 to 175 min.
37. The method of embodiment 36, wherein providing the catalyst in (a) comprises selecting the catalyst among catalysts displaying a water adsorption in the range of from 1 to 7.9 wt.-%, preferably from 3 to 7.5 wt.-%, more preferably from 4 to 7 wt.-%, more preferably from 4.5 to 6.5 wt.-%, and more preferably from 5 to 6 wt.-%.
38. The method of embodiments 36 or 37, wherein providing the catalyst in (a) comprises selecting the catalyst among catalysts displaying a concentration (C) of bridging μ² η²-peroxo species per Ti in the H₂O₂-activated catalyst as determined by quantitative 170 NMR spectroscopy, preferably determined according to Reference Example 1.3, in the range of from 300 to 822 mmol/mol, preferably from 350 to 800 mmol/mol, more preferably from 400 to 780 mmol/mol, more preferably from 450 to 760 mmol/mol, more preferably from 500 to 740 mmol/mol, more preferably from 550 to 720 mmol/mol, and more preferably from 600 to 700 mmol/mol.
39. The method of any one of embodiments 36 to 38, wherein T is in the range of from 75 to 165 min, preferably from 85 min to 155 min, more preferably from 95 to 145 min, more preferably from 105 to 135 min, more preferably from 112 to 128 min, more preferably from 116 to 124 min, more preferably from 118 to 122 min, and more preferably from 119 to 121 min, wherein more preferably T is 120 min.
40. The method of any one of embodiments 36 to 39, wherein the activation factor (A) is in the range of from 16 to 75 mmol/mol, preferably from 18 to 67 mmol/mol, more preferably from 20 to 65 mmol/mol, more preferably from 22 to 60 mmol/mol, more preferably from 24 to 55 mmol/mol, more preferably from 26 to 50 mmol/mol, more preferably from 27 to 45 mmol/mol, more preferably from 28 to 40 mmol/mol, more preferably from 29 to 37 mmol/mol, and more preferably from 30 to 34 mmol/mol.
41. The method of any one of embodiments 30 to 40, wherein providing the catalyst in (a) comprises selecting the catalyst among catalysts comprising from 0 to 1 weight-%, preferably from 0 to 0.1 weight-%, more preferably from 0 to 0.01 weight-%, more preferably from 0 to 0.001 weight-%, of B, calculated as the element and based on the total weight of the catalyst.
42. The method of any one of embodiments 30 to 41, wherein providing the catalyst in (a) comprises selecting the catalyst among catalysts comprising from 0 to 1 weight-%, preferably from 0 to 0.1 weight-%, more preferably from 0 to 0.01 weight-%, more preferably from 0 to 0.001 weight-%, of Na, calculated as the element and based on the total weight of the catalyst.
43. The method of any one of embodiments 30 to 42, wherein providing the catalyst in (a) comprises selecting the catalyst among catalysts comprising from 0 to 1 weight-%, preferably from 0 to 0.1 weight-%, more preferably from 0 to 0.01 weight-%, more preferably from 0 to 0.001 weight-%, of Ge, calculated as the element and based on the total weight of the catalyst.
44. The method of any one of embodiments 30 to 43, wherein providing the catalyst in (a) comprises selecting the catalyst among catalysts comprising from 0 to 1 weight-%, preferably from 0 to 0.5 weight-%, more preferably from 0 to 0.2 weight-%, more preferably from 0 to 0.1 weight-%, of C, calculated as the element and based on the total weight of the catalyst.
45. The method of any one of embodiments 30 to 44, wherein providing the catalyst in (a) comprises selecting the catalyst among catalysts exhibiting a propylene oxide activity of at least 2.0 weight-%, preferably in the range of from 3.0 to 15.0 weight-%, more preferably in the range of from 9.0 to 13.0 weight-%, preferably determined as described in Reference Example 1.6.
46. The method of any one of embodiments 30 to 45, wherein the one or more binders in (b) are selected from the group consisting of inorganic binders, wherein the one or more binders preferably comprise one or more sources of a metal oxide and/or of a metalloid oxide, more preferably one or more sources of a metal oxide and/or of a metalloid oxide selected from the group consisting of silica, alumina, titania, zirconia, lanthana, magnesia, and mixtures and/or mixed oxides of two or more thereof, more preferably from the group consisting of silica, alumina, titania, zirconia, magnesia, silica-alumina mixed oxides, silica-titania mixed oxides, silica-zirconia mixed oxides, silica-lanthana mixed oxides, silica-zirconia-lanthana mixed oxides, alumina-titania mixed oxides, alumina-zirconia mixed oxides, alumina-lanthana mixed oxides, alumina-zirconia-lanthana mixed oxides, titania-zirconia mixed oxides, and mixtures and/or mixed oxides of two or more thereof, more preferably from the group consisting of silica, alumina, silica-alumina mixed oxides, and mixtures of two or more thereof, wherein more preferably the one or more binders in (b) comprise one or more sources of silica, wherein more preferably the one or more binders in (b) consist of one or more sources of silica, wherein the one or more sources of silica preferably comprise one or more compounds selected from the group consisting of fumed silica, colloidal silica, silica-alumina, colloidal silica-alumina, and mixtures of two or more thereof, more preferably one or more compounds selected from the group consisting of fumed silica, colloidal silica, and mixtures thereof, wherein more preferably the one or more binders in (b) consist of colloidal silica.
47. The method of any one of embodiments 30 to 46, wherein step (b) further comprises mixing the zeolitic material and the one or more binders with a solvent system, wherein the solvent system comprises one or more solvents, wherein preferably the solvent system comprises one or more hydrophilic solvents, the hydrophilic solvents preferably being selected from the group consisting of polar solvents, more preferably from the group consisting of polar protic solvents, wherein more preferably the solvent system comprises one or more polar protic solvents selected from the group consisting of water, alcohols, carboxylic acids, and mixtures of two or more thereof, more preferably from the group consisting of water, C1-C5 alcohols, C1-C5 carboxylic acids, and mixtures of two or more thereof, more preferably from the group consisting of water, C1-C4 alcohols, C1-C4 carboxylic acids, and mixtures of two or more thereof, more preferably from the group consisting of water, C1-C3 alcohols, C1-C3 carboxylic acids, and mixtures of two or more thereof, more preferably from the group consisting of water, methanol, ethanol, propanol, formic acid, acetic acid, and mixtures of two or more thereof, more preferably from the group consisting of water, ethanol, acetic acid, and mixtures of two or more thereof, wherein more preferably the solvent system comprises water and/or ethanol, and wherein more preferably the solvent system comprises water, wherein even more preferably the solvent system consists of water.
48. The method of any one of embodiments 30 to 47, wherein step (b) further comprises mixing the zeolitic material and the one or more binders with one or more pore forming agents and/or lubricants and/or plasticizers, wherein the one or more pore forming agents and/or lubricants and/or plasticizers are preferably selected from the group consisting of polymers, carbohydrates, graphite, plant additives, and mixtures of two or more thereof, more preferably from the group consisting of polymeric vinyl compounds, polyalkylene oxides, polyacrylates, polyolefins, polyamides, polyesters, cellulose and cellulose derivatives, sugars, sesbania cannabina, and mixtures of two or more thereof, more preferably from the group consisting of polystyrene, C2-C3 polyalkylene oxides, cellulose derivatives, sugars, and mixtures of two or more thereof, more preferably from the group consisting of polystyrene, polyethylene oxide, C1-C2 hydroxyalkylated and/or C1-C2 alkylated cellulose derivatives, sugars, and mixtures of two or more thereof, more preferably from the group consisting of polystyrene, polyethylene oxide, hydroxyethyl methyl cellulose, and mixtures of two or more thereof, wherein more preferably the one or more pore forming agents and/or lubricants and/or plasticizers consists of one or more selected from the group consisting of polystyrene, polyethylene oxide, hydroxyethyl methyl cellulose, and mixtures of two or more thereof, and more preferably wherein the one or more pore forming agents and/or lubricants and/or plasticizers consist of a mixture of polystyrene, polyethylene oxide, and hydroxyethyl methyl cellulose.
49. The method of any one of embodiments 30 to 49, wherein the calcining of the dried molding obtained in step (e) is performed at a temperature ranging from 350 to 850° C., preferably from 400 to 700° C., more preferably from 450 to 650° C., and more preferably from 475 to 600° C.
50. A catalyst molding comprising a catalyst for hydrogen peroxide activation according to any of embodiments 1 to 29, wherein the catalyst molding is preferably obtainable or obtained by a process according to any one of embodiments 30 to 49.
51. A process for the activation of hydrogen peroxide comprising:
   (1) providing a reactor comprising a catalyst for hydrogen peroxide activation according to any of embodiments 1 to 29, or a catalyst molding according to embodiment 48;
   (2) contacting the catalyst or catalyst molding provided in (1) with hydrogen peroxide.
52. The process of embodiment 51, wherein providing the catalyst in (1) comprises selecting the catalyst among catalysts comprising Ti, Si, and O, and displaying
   a water adsorption (W), preferably determined according to Reference Example 1.1, and
   a concentration (C) of bridging μ² η²-peroxo species per Ti in the H₂O₂-activated catalyst as determined by quantitative ¹⁷O NMR spectroscopy, preferably according to Reference Example 1.3;
   wherein the catalyst is selected by calculating an activation factor (A) in accordance with formula I for each of the catalysts, and selecting a catalyst displaying an activation factor in the range of from 15 to 80 mmol/mol, wherein the activation factor is the multiplication product of the water adsorption and the concentration of bridging μ² η²-peroxo species per Ti in the H₂O₂-activated catalyst:

$$A = W \times C . \qquad ( I )$$

53. The process of embodiment 52, wherein providing the catalyst in (1) comprises selecting the catalyst among catalysts displaying a water adsorption in the range of from 1 to 10 wt.-%, preferably from 1.5 to 9.5 wt.-%, more preferably from 2 to 9 wt.-%, more preferably from 2.5 to 8.5 wt.-%, more preferably from 3 to 8 wt.-%, more preferably from 3.2 to 7.9 wt.-%, more preferably from 3.5 to 7.5 wt.-%, more preferably from 4 to 7 wt.-%, more preferably from 4.5 to 6.5 wt.-%, and more preferably from 5 to 6 wt.-%.
54. The process of embodiment 52 or 53, wherein providing the catalyst in (1) comprises selecting the catalyst among catalysts displaying a concentration of bridging μ² η²-peroxo species per Ti in the H₂O₂-activated catalyst in the range of from 200 to 1,200 mmol/mol, preferably from 300 to 1,000 mmol/mol, more preferably from 350 to 950 mmol/mol, more preferably from 400 to 900 mmol/mol, more preferably from 450 to 850 mmol/mol, more preferably from 500 to 800 mmol/mol, more preferably from 550 to 750 mmol/mol, and more preferably from 600 to 700 mmol/mol.
55. The process of any one of embodiments 52 to 54, wherein the catalyst is selected by calculating an activation factor (A) for each of the catalysts, and selecting a catalyst displaying an activation factor in the range of from 16 to 70 mmol/mol, more preferably from 18 to 60 mmol/mol, more preferably from 20 to 55 mmol/mol, more preferably from 23 to 50 mmol/mol, more preferably from 25 to 45 mmol/mol, more preferably from 26 to 44 mmol/mol, more preferably from 27 to 42 mmol/mol, more preferably from 28 to 40 mmol/mol, more preferably from 29 to 37 mmol/mol, and more preferably from 30 to 35 mmol/mol.
56. The process of any one of embodiments 52 to 55, wherein the concentration (C) of bridging μ² η²-peroxo species per Ti in the H₂O₂-activated catalyst as determined by quantitative ¹⁷O NMR spectroscopy is the concentration which is determined at a time point T after having brought the catalyst into contact with H₂¹⁷O₂, wherein T is in the range of from 1 to 720 min after having brought the catalyst into contact with H₂¹⁷O₂, preferably from 2 min to 480 min, more preferably from 4 to 240 min, more preferably from 6 to 120 min, more preferably from 8 to 60 min, more preferably from 10 to 30 min, more preferably from 12 to 20 min, and more preferably from 14 to 16 min, wherein more preferably T is 15 min.
57. The process of embodiment 52, wherein providing the catalyst in (1) comprises selecting the catalyst among catalysts displaying a concentration (C) of bridging μ² η² peroxo species per Ti in the H₂O₂-activated catalyst as determined by quantitative 170 NMR spectroscopy in the range of from 200 to 825 mmol/mol, wherein the concentration (C) of bridging μ² η²-peroxo species per Ti in the H₂O₂-activated catalyst as determined by quantitative ¹⁷O NMR spectroscopy is the concentration which is determined at a time point T after having brought the catalyst into contact with H₂¹⁷O₂, wherein T is in the range of from 65 to 175 min.
58. The process of embodiment 57, wherein providing the catalyst in (1) comprises selecting the catalyst among catalysts displaying a water adsorption in the range of from 1 to 7.9 wt.-%, preferably from 3 to 7.5 wt.-%, more preferably from 4 to 7 wt.-%, more preferably from 4.5 to 6.5 wt.-%, and more preferably from 5 to 6 wt.-%.
59. The process of embodiment 57 or 58, wherein providing the catalyst in (1) comprises selecting the catalyst among catalysts displaying a concentration (C) of bridging μ² η² peroxo species per Ti in the H₂O₂-activated catalyst as determined by quantitative 170 NMR spectroscopy, preferably determined according to Reference Example 1.3, in the range of from 300 to 822 mmol/mol, preferably from 350 to 800 mmol/mol, more preferably from 400 to 780 mmol/mol, more preferably from 450 to 760 mmol/mol, more preferably from 500 to 740 mmol/mol, more preferably from 550 to 720 mmol/mol, and more preferably from 600 to 700 mmol/mol.
60. The process of any one of embodiments 57 to 59, wherein T is in the range of from 75 to 165 min, preferably from 85 min to 155 min, more preferably from 95 to 145 min, more preferably from 105 to 135 min, more preferably from 112 to 128 min, more preferably from 116 to 124 min, more preferably from 118 to 122 min, and more preferably from 119 to 121 min, wherein more preferably T is 120 min.
61. The process of any one of embodiments 57 to 60, wherein the activation factor (A) is in the range of from 16 to 75 mmol/mol, preferably from 18 to 67 mmol/mol, more preferably from 20 to 65 mmol/mol, more preferably from 22 to 60 mmol/mol, more preferably from 24 to 55 mmol/mol, more preferably from 26 to 50 mmol/mol, more preferably from 27 to 45 mmol/mol, more preferably from 28 to 40 mmol/mol, more preferably from 29 to 37 mmol/mol, and more preferably from 30 to 34 mmol/mol.
62. The process of any one of embodiments 51 to 61, wherein providing the catalyst in (1) comprises selecting the catalyst among catalysts comprising from 0 to 1 weight-%, preferably from 0 to 0.1 weight-%, more preferably from 0 to 0.01 weight-%, more preferably from 0 to 0.001 weight-%, of B, calculated as the element and based on the total weight of the catalyst.
63. The process of any one of embodiments 51 to 62, wherein providing the catalyst in (1) comprises selecting the catalyst among catalysts comprising from 0 to 1 weight-%, preferably from 0 to 0.1 weight-%, more preferably from 0 to 0.01 weight-%, more preferably from 0 to 0.001 weight-%, of Na, calculated as the element and based on the total weight of the catalyst.
64. The process of any one of embodiments 51 to 63, wherein providing the catalyst in (1) comprises selecting the catalyst among catalysts comprising from 0 to 1 weight-%, preferably from 0 to 0.1 weight-%, more preferably from 0 to 0.01 weight-%, more preferably from 0 to 0.001 weight-%, of Ge, calculated as the element and based on the total weight of the catalyst.
65. The process of any one of embodiments 51 to 64, wherein providing the catalyst in (1) comprises selecting the catalyst among catalysts comprising from 0 to 1 weight-%, preferably from 0 to 0.5 weight-%, more preferably from 0 to 0.2 weight-%, more preferably from 0 to 0.1 weight-%, of C, calculated as the element and based on the total weight of the catalyst.
66. The process of any one of embodiments 51 to 65, wherein providing the catalyst in (1) comprises selecting the catalyst among catalysts exhibiting a propylene oxide activity of at least 2.0 weight-%, preferably in the range of from 3.0 to 15.0 weight-%, more preferably in the range of from 9.0 to 13.0 weight-%, preferably determined as described in Reference Example 1.6.
67. The process of any one of embodiments 51 to 66, wherein in (2) hydrogen peroxide is comprised in a liquid feed stream which is fed into the reactor, wherein the liquid feed stream further comprises one or more unsaturated organic compounds, preferably one or more olefins, more preferably one or more C2-C5 alkenes, more preferably one or more C2-C4 alkenes, more preferably one or more C2 or C3 alkenes, more preferably propylene.
68. The process of embodiment 67, wherein the liquid feed stream further comprises a solvent system, wherein the solvent system comprises one or more solvents, wherein preferably the solvent system comprises one or more hydrophilic solvents, the hydrophilic solvents preferably being selected from the group consisting of polar solvents, more preferably from the group consisting of polar protic solvents, wherein more preferably the solvent system comprises one or more polar protic solvents selected from the group consisting of water, alcohols, and mixtures of two or more thereof, more preferably from the group consisting of water, C1-C5 alcohols, and mixtures of two or more thereof, more preferably from the group consisting of water, C1-C4 alcohols, and mixtures of two or more thereof, more preferably from the group consisting of water, C1-C3 alcohols, and mixtures of two or more thereof, more preferably from the group consisting of water, methanol, ethanol, propanol, and mixtures of two or more thereof, more preferably from the group consisting of water, methanol, and mixtures thereof, wherein more preferably the solvent system comprises water, preferably water and methanol, wherein more preferably the solvent system consists of water and methanol.
69. The process of embodiment 67 or 68, wherein the liquid feed stream comprises hydrogen peroxide at a concentration in the range of from 1 to 75 weight-%, preferably from 3 to 50 weight-%, 5 to 30 weight-%, more preferably from 7 to 25 weight-%, more preferably from 8 to 20 weight-%, more preferably from 9 to 15 weight-%, more preferably from 10 to 12 weight-%, based on the total weight of the liquid feed stream.
70. The process of any one of embodiments 67 to 69, wherein the liquid feed stream fed into the reactor in (2) has a temperature in the range of from 0 to 60° C., preferably from 25 to 50° C.
71. The process of any one of embodiments 67 to 70, wherein the liquid feed stream fed into the reactor in (2) is at a pressure in the range of from 5 to 100 bar, preferably from 10 to 50 bar, more preferably from 15 to 25 bar.
72. The process of any one of embodiments 67 to 71, wherein contacting in (2) is conducted at a temperature in the range of from 10 to 100° C., preferably from 25 to 80° C., more preferably from 30 to 75° C., more preferably from 40 to 65° C.
73. The process of any one of embodiments 67 to 72, wherein contacting in (2) is conducted at a pressure in the range of from 5 to 100 bar, preferably from 10 to 50 bar, more preferably from 14 to 32 bar, more preferably from 15 to 25 bar, wherein the pressure is defined as the pressure at the exit of the reactor.
74. The process of any one of embodiments 67 to 73, wherein the catalyst loading in the reactor in (1) is in the range of from 0.05 to 5 h⁻¹, preferably from 0.1 to 4 h⁻¹, more preferably from 0.2 to 3.5 h⁻¹, more preferably from 0.7 to 3 h⁻¹, more preferably from 1 to 2.75 h⁻¹, more preferably from 1.25 to 2.5 h⁻¹, more preferably from 1.5 to 2.25 h⁻¹, more preferably from 1.75 to 2 h⁻¹, wherein the catalyst loading is defined as the ratio of the mass flow rate in kg/h of hydrogen peroxide contained in the liquid feed stream divided by the amount in kg of the catalyst comprised in the reactor in (1).
75. The process of any one of embodiments 67 to 74, wherein the process further comprises
   (3) removing an effluent stream from the reactor, the effluent stream comprising an oxidized organic compound, and preferably comprising an epoxidized organic compound, more preferably an alkylene oxide, more preferably an alkylene oxide selected from C2-C5 alkylene oxides, more preferably from C2-C4 alkylene oxides, more preferably from C2 or C3 alkylene oxides, more preferably from C3 alkylene oxides, wherein more preferably the effluent stream comprises propylene oxide.
76. Use of the catalyst according to any one of embodiments 1 to 29, or of a catalyst molding according to claim 48, as a catalyst and/or catalyst component in a reaction involving C—C bond formation and/or conversion, and preferably as a catalyst and/or catalyst component in an isomerization reaction, in an ammoximation reaction, in an amination reaction, in a hydrocracking reaction, in an alkylation reaction, in an acylation reaction, in a reaction for the conversion of alkanes to olefins, or in a reaction for the conversion of one or more oxygenates to olefins and/or aromatics, in a reaction for the synthesis of hydrogen peroxide, in an aldol condensation reaction, in a reaction for the isomerization of epoxides, in a transesterification reaction, in a hydroxylation reaction, in a Baeyer-Villiger-type oxidation reaction, in a Dakin-type reaction, or in an epoxidation reaction, preferably as a catalyst and/or catalyst component in a hydroxylation reaction, in a Baeyer-Villiger-type oxidation reaction, in a Dakin-type reaction, or in a reaction for the epoxidation of olefins, more preferably in a reaction for the epoxidation of olefins, more preferably in a reaction for the epoxidation of C2-C5 alkenes, more preferably in a reaction for the epoxidation of C2-C4 alkenes, in a reaction for the epoxidation of C2 or C3 alkenes, more preferably for the epoxidation of C3 alkenes, and more preferably as a catalyst or catalyst component for the conversion of propylene to propylene oxide.

The present invention is further illustrated by the following examples, comparative examples and reference examples.

### EXPERIMENTAL SECTION

### Reference Example 1: Determination Methods

### Reference Example 1.1: Determination of Water Adsorption

Determination of the water adsorption properties of the examples of the experimental section was performed on a VTI SA instrument from TA Instruments following a step-isotherm program. The experiment consisted of a run or a series of runs performed on a sample material that has been placed on the microbalance pan inside of the instrument. Before a measurement was started, residual moisture of a sample was removed by heating the sample to 120° C. (heating ramp of 5° C./min) and holding it for 6 h under a N₂ flow. After the drying program, the temperature in the cell was decreased to 25° C. and kept isothermal during the measurements. The microbalance was calibrated, and the weight of the dried sample was balanced (maximum mass deviation 0.01 wt. %). Water uptake by the sample was measured as the increase in weight over that of the dry sample. First, an adsorption curve was measured by increasing the relative humidity (RH) to which the samples was exposed and measuring the water uptake by the sample at equilibrium. The RH was increased with a step of 10% from 5 to 85% and at each step the system controlled the RH and monitored the sample weight until reaching the equilibrium conditions and recording the weight uptake. The total adsorbed water amount by the sample was taken after the sample was exposed to the 85% RH. During the desorption measurement the RH was decreased from 85% to 5% with a step of 10% and the change in the weight of the samples (water uptake) was monitored and recorded.

### Reference Example 1.2: Determination of Ti K Edge XANES Spectra

Ti K edge XANES (X-ray absorption near edge structure) spectra were recorded at the European Synchrotron Radiation Facility (Grenoble, France). The X-ray beam was monochromatized using a liquid nitrogen cooled Si (111) monochromator. A calibration of the energy was performed using Ti reference foil (Ti K-edge position at 4966 eV). The XAS K-edge measurements were carried out with a fluorescent scheme of detection using a silicon drift diode with associated digital electronics. All samples were measured as pressed pellets.

Ti K edge XANES is highly sensitive to the local coordination sphere of Ti. Characteristic features can be observed both in the pre-edge and whiteline regions, respectively. For the analysis of Ti in titanium silicalite-1 (TS-1) and the determination of the structure of extra-framework TiO₂, bulk TiO₂ references, e.g., anatase and rutile, were measured first. As can be seen in FIG. 1, anatase showed pre-edge features at 4969 eV, 4971 eV, 4972 eV and 4974 eV, respectively and a sharp first whiteline feature at 4987 eV. Rutile showed pre-edge features at 4969 eV, 4971 eV and 4974 eV, respectively, a moderate first whiteline feature at 4987 eV and a more pronounced feature at 4992 eV. For a titanosilicalite where all titanium is incorporated into the framework and in tetrahedral geometry, only one distinct feature at 4970 eV was observed in the pre-edge region and none in the whiteline region.

As regards the XANES spectrum of anatase, it displays a ratio of the intensity of the signal at 4987 eV to the intensity of the signal at 4992 eV of 1.07 (1.17:1.09=1.07). On the other hand, the XANES spectrum of rutile displays a ratio of the intensity of the signal at 4987 eV to the intensity of the signal at 4992 eV of 0.97 (1.12:1.16=0.97).

### Reference Example 1.3: Determination of the Concentration of Bridging μ² η²-Peroxo Species in an H₂O₂-Activated Catalyst Via ¹⁷O NMR Spectroscopy

All NMR measurements were obtained on a Bruker Avance III 600-MHz NMR spectrometer (14.1 T) at low temperatures (100 K) using a 3.2-mm probe. The magnetic field was externally referenced by setting the signal of liquid H₂O (at room temperature) to 0 ppm. Measurements were performed in a 3.2-mm sapphire rotor closed with a zirconia cap. Static WURST-CPMG (wideband, uniform-rate and smooth-truncation pulse with CPMG echotrain acquisition) experiments were performed to obtain the ¹⁷O NMR spectra. Details of the WURST pulse were as follows: length, 50 μs; 80 steps; sweep width, 0.5 MHz, sweeping from low to high frequency. SPINAL64 with 100 kHz radio frequency was used for 1H decoupling.

A TS-1 sample with ¹⁷O-labelled H₂O₂ was prepared by impregnating 25 mg of a TS-1 zeolite with one equivalent (with respect to Ti) of a 1.6 M aqueous solution of ¹⁷O-labelled H₂O₂. The samples were left to equilibrate for 15 min or 2 h before spectroscopic measurements.

As indicated above, a TS-1 sample was probed using solid-state ¹⁷O NMR spectroscopy at 100 K. This approach enables the observation of reaction intermediates that originate from the activation of H₂¹⁷O₂, while at low temperature possible signal averaging due to dynamics is avoided and peroxo decomposition is prevented. The solid-state ¹⁷O NMR spectra of H₂¹⁷O₂ and H₂¹⁷O were also recorded, because these molecules are probably present in the catalyst sample.

The solid-state NMR spectra of TS-1 samples at various Ti loadings contacted with one equivalent (with respect to Ti) of a 1.6 M H₂¹⁷O₂ solution for 2 h showed that H₂¹⁷O₂ reacted in all cases and that two new main signals of comparable intensity appeared.

To probe peroxo formation rates and stability a quantification protocol was established. First, a WURST QCMPG spectrum was measured (as described above) and subsequently the echo spectrum was reconstructed and then deconvolved into components associated with H₂O, H₂O₂ and peroxo species.

To avoid overfitting, the experimentally obtained spectrum of H₂O, H₂O₂ and peroxo were fitted individually using DM Fit (see FIG. 1). DM Fit is described by D. Massiot et al. in Magnetic Resonance in Chemistry 2002, vol. 40, pages 70-76.

The initial guess for each component was based on the previously DFT calculated NMR parameters in C. P. Gordon et al., Nature 2020, 586, 708-713, and the relative intensity of each species was optimized to converge to a best fit that provides the ratio of each species. Based on said DFT calculations the observed ¹⁷O NMR signal were assigned. The respective concentrations were obtained by multiplication of these ratios with the initial concentration (1.6 M) of the aqueous stock solution of H₂¹⁷O₂ that was used for the wet impregnation.

The relative values for H₂¹⁷O₂, bridging μ² η²-peroxo, and H₂¹⁷O (see “rel. H₂O₂”, “rel. μ-peroxo” and “rel. H₂O” in table 1 below) after 15 min and after 2 hours were obtained from the measurements and applying the above quantification protocol.

The concentration of bridging μ² η²-peroxo species in a H₂¹⁷O₂-activated sample was calculated based on the value for the rel. bridging μ² η²-peroxo concentration according to the following calculation:

(concentration of bridgingμ²η²-peroxo species)=[(rel. bridgingμ²η²-peroxo concentration)×(concentration of H₂¹⁷O₂ solution)×(volume of ¹⁷O-labelled H₂O₂ solution used for wet impregnation)]/[weight of the catalyst sample in mg]

From said concentration the molar concentration of bridging μ² η²-peroxo species per titanium (i.e. mol bridging μ² η²-peroxo per mol Ti) was calculated.

### Reference Example 1.4: X-Ray Powder Diffraction and Determination of the Crystallinity

Powder X-ray diffraction (PXRD) data was collected using a diffractometer (D8 Advance Series II, Bruker AXS GmbH) equipped with a LYNXEYE detector operated with a Copper anode X-ray tube running at 40 kV and 40 mA. The geometry was Bragg-Brentano, and air scattering was reduced using an air scatter shield.

Computing crystallinity for TS-1: The crystallinity calculations were performed using a calibration routine. Various mixtures of an ideally crystallized sample with the dried initial crystallization suspension without seeding crystals are created in which the crystalline material has a mass percent of 30%, 40%, 50%, 60%, 70%, 80%, 90% and 100%. These samples were measured as described below. The analysis was performed by determining the net intensities between the diffraction angles of 21.3° 2Theta and 25° 2Theta. This is performed using the “area” tool within DIFFRAC.EVA provided by Bruker AXS GmbH, Karlsruhe (User Manual for DIFFRAC.EVA Version 5, April 2019, Bruker AXS GmbH, Karlsruhe).

$${c}_{r} = {I}_{sample} / {I}_{standard}$$

Where Iₛₐₘₚₗₑ is the net intensity of the sample and I_{standard} is the net intensity of the standard. The raw crystallinity value was determined by calculating the net area of the sample divided by the net area of the standard sample. This is corrected by the linear calibration function

$$c = {c}_{r} * a + b ,$$

where a and b are the coefficients determined using the calibration data.

Computing phase composition: The phase composition was computed against the raw data using the modelling software DIFFRAC. TOPAS provided by Bruker AXS GmbH (User Manual for DIFFRAC.TOPAS Version 6, 2017, Bruker AXS GmbH, Karlsruhe). The crystal structures of the identified phases, instrumental parameters as well the crystallite size of the individual phases were used to simulate the diffraction pattern. This was fit against the data in addition to a function modelling the background intensities.

Data collection: The samples were homogenized in a mortar and then pressed into a standard flat sample holder provided by Bruker AXS GmbH for Bragg-Brentano geometry data collection. The flat surface was achieved using a glass plate to compress and flatten the sample powder. The data was collected from the angular range 2 to 50° 2Theta with a step size of 0.02° 2Theta, while the variable divergence slit was set to an angle of 0.1°. The crystalline content describes the intensity of the crystalline signal to the total scattered intensity.

### Reference Example 1.5: Determination of the BET Specific Surface Area and the Micropore Volume

The BET specific surface area and the micropore volume were determined via nitrogen physisorption at 77 K according to the method disclosed in DIN 66131.

### Reference Example 1.6: Determination of the Propylene Oxide Activity (PO Test)

In the PO test, a preliminary test procedure to assess the possible suitability of the moldings as catalyst for the epoxidation of propene, the moldings were tested in a glass autoclave by reaction of propene with an aqueous hydrogen peroxide solution (30 weight-%) to yield propylene oxide. In particular, 0.5 g of the molding were introduced together with 45 mL of methanol in a glass autoclave, which was cooled to −25° C. 20 mL of liquid propene were pressed into the glass autoclave and the glass autoclave was heated to 0° C. At this temperature, 18 g of an aqueous hydrogen peroxide solution (30 weight-% in water) were introduced into the glass autoclave. After a reaction time of 5 h at 0° C., the mixture was heated to room temperature and the liquid phase was analyzed by gas chromatography with respect to its propylene oxide content. The propylene oxide content of the liquid phase (in weight-%) is the result of the PO test, i.e. the propylene oxide acitivity of the molding.

### Reference Example 1.7: K-80 Test

The k80-test was designed as a semi-quantitative experiment to assess the rate of decomposition of H₂O₂ by TS-1 and similar titanium containing zeolites. It allows to quantitatively determine the effect of different catalyst treatments on the decomposition of H₂O₂.

### Experimental Procedure

In a clean 100 ml flask with a magnetic stirring bar and a thermometer were placed 30 g of deionised water and 6.5 g of a 40 weight-% hydrogen peroxide solution at room temperature. At this point a t=0 probe of ca. 0.3 ml is taken with a pipette. The flask is lightly stoppered and then immersed in a previously equilibrated thermostating bath set to 80° C. To obtain reproducible results it is important to use always the same amount of catalyst and to control the temperature to better than +1° C. during the experiment. As soon as the hydrogen peroxide solution is in thermal equilibrium with the thermostating bath, 500 mg (+1 mg) of the catalyst (either powder or extrudates) are added. The suspension is stirred and samples of the supernatant liquid are then taken at regular intervals. The probe should be taken with a 1 ml syringe with a one-way filter Millipore Millex-HV SLHV 013 NL (order number 4875 160) or equivalent. First 0.6 ml of solution are sucked into the syringe through the filter. Then 0.3 ml of the solution are back-flushed through the filter in to the flask. This is necessary in order to minimise loss of catalyst. The remaining 0.3 ml in the syringe are then used for the peroxide determination. The interval between probes is usually between 30 and 60 min depending on the catalyst activity.

The experiment is finished after 7 hours.

### Analytics

The probes are analysed for H₂O₂ content by using a standard cerimetric titration. It is advisable to analyse the probes as soon as possible after they are collected. In order to ensure a good precision the amount of titrating solution used should be at least 5 ml. If necessary a larger amount of probe has to be weighed in.

### Data Analysis

The natural logarithm of the H₂O₂ concentration is plotted against time. It is important to always use the same units when comparing data (for instance H₂O₂ concentration in weight-% and time in hours). This plot usually gives a good straight line. Using least squares methods the slope is extracted. This slope is the pseudo-first order decay rate of H₂O₂ in the presence of the catalyst (in h⁻¹) and is called the k80 value.

### Example 1: Preparation of a TS-1 Catalyst in Accordance with the Present Invention

For the gel preparation, 500 g tetraethylorthosilicate (TEOS) and 3.75 g tetraethylorthotitanate (TEOTi; Merck) were filled into a beaker. Then, a solution of 300 g de-ionized water and 220 g aqueous tetrapropylammonium hydroxide (TPAOH; 40 weight-% in water) was added under stirring (200 rpm). The resulting mixture had a pH of 13.81. The mixture was hydrolyzed at room temperature for 60 min during which the temperature rose to 60° C. The mixture had a pH of 12.91 then. Afterwards the ethanol was distilled off until the sump reached a temperature of 95° C. 546 g of distillate was obtained from distillation.

The synthesis gel was then cooled to 40° C. under stirring and 546 g de-ionized water added thereto. The resulting mixture had a pH of 11.91.

The synthesis gel was then transferred into an autoclave. The synthesis gel was heated under stirring in the autoclave to a temperature of 175° C. and stirred at said temperature for 16 h under autogenous pressure. The pressure was in the range of from 8.4 to 11.9 bar (abs). The resulting suspension was then worked-up. To this effect, the resulting suspension was diluted with de-ionized water, wherein the weight ratio of the suspension to de-ionized water was 1:1. Then, about 150 g nitric acid (10 weight-% in water) were added and the resulting mixture had a pH of 7.53. The obtained solids were filtered off and washed three times with de-ionized water (each time 1000 ml de-ionized water were used). Subsequently, the solids were dried in an oven in air at 120° C. for 4 h and then calcined in air at 490° C. for 5 h, wherein the heating rate for calcining was 2° C./min.

The resulting product had a Si content of 44 weight-%, a Ti content of 0.52 weight-%, and a total loss of carbon of less than 0.1 weight-%. The BET specific surface area of the resulting product was 443 m²/g, and the water adsorption 7.5 wt.-%. The crystallinity was 96% and no anatase was detectable by X-ray diffraction.

The XANES spectrum of the product was determined, wherein the catalyst displays a ratio of the intensity of the signal at 4987 eV to the intensity of the signal at 4992 eV of 0.95 (1.03:1.08=0.95). The results for the PO test and for the K80-test are shown in tables 4 and 5, respectively.

### Example 2: Preparation of a TS-1 Catalyst in Accordance with the Present Invention

For the gel preparation, 500 g tetraethylorthosilicate (TEOS) and 7.5 g tetraethylorthotitanate (TEOTi; Merck) were filled into a beaker. Then, a solution of 300 g de-ionized water and 220 g aqueous tetrapropylammonium hydroxide (TPAOH; 40 weight-% in water) was added under stirring (200 rpm). The resulting mixture had a pH of 13.81. The mixture was hydrolyzed at room temperature for 60 min during which the temperature rose to 60° C. The mixture had a pH of 12.71 then. Afterwards the ethanol was distilled off until the sump reached a temperature of 95° C. 548 g of distillate was obtained from distillation.

The synthesis gel was then cooled to 40° C. under stirring and 548 g de-ionized water added thereto. The resulting mixture had a pH of 12.01.

The synthesis gel was then transferred into an autoclave. The synthesis gel was heated under stirring in the autoclave to a temperature of 175° C. and stirred at said temperature for 16 h under autogenous pressure. The pressure was in the range of from 8.2 to 11.4 bar (abs). The resulting suspension was then worked-up. To this effect, the resulting suspension was diluted with de-ionized water, wherein the weight ratio of the suspension to de-ionized water was 1:1. Then, about 155 g nitric acid (10 weight-% in water) were added and the resulting mixture had a pH of 7.28. The obtained solids were filtered off and washed three times with de-ionized water (each time 1000 ml de-ionized water were used). Subsequently, the solids were dried in an oven in air at 120° C. for 4 h and then calcined in air at 490° C. for 5 h, wherein the heating rate for calcining was 2° C./min.

The resulting product had a Si content of 43 weight-%, a Ti content of 1.0 weight-%, and a total loss of carbon of less than 0.1 weight-%. The BET specific surface area of the resulting product was 450 m²/g, and the water adsorption 8.45 wt.-%. The crystallinity was 100% and no anatase was detectable by X-ray diffraction.

The XANES spectrum of the product was determined, wherein the catalyst displays a ratio of the intensity of the signal at 4987 eV to the intensity of the signal at 4992 eV of 0.96 (1.05:1.09=0.96). The results for the PO test and for the K80-test are shown in tables 4 and 5, respectively.

### Example 3: Preparation of a TS-1 Catalyst in Accordance with the Present Invention

For the gel preparation, 500 g tetraethylorthosilicate (TEOS) and 11.25 g tetraethylorthotitanate (TEOTi; Merck) were filled into a beaker. Then, a solution of 300 g de-ionized water and 220 g aqueous tetrapropylammonium hydroxide (TPAOH; 40 weight-% in water) was added under stirring (200 rpm). The resulting mixture had a pH of 13.79. The mixture was hydrolyzed at room temperature for 60 min during which the temperature rose to 60° C. The mixture had a pH of 12.85 then. Afterwards the ethanol was distilled off until the sump reached a temperature of 95° C. 546 g of distillate was obtained from distillation.

The synthesis gel was then cooled to 40° C. under stirring and 546 g de-ionized water added thereto. The resulting mixture had a pH of 11.86.

The synthesis gel was then transferred into an autoclave. The synthesis gel was heated under stirring in the autoclave to a temperature of 175° C. and stirred at said temperature for 16 h under autogenous pressure. The pressure was in the range of from 8.4 to 11.9 bar (abs). The resulting suspension was then worked-up. To this effect, the resulting suspension was diluted with de-ionized water, wherein the weight ratio of the suspension to de-ionized water was 1:1. Then, about 150 g nitric acid (10 weight-% in water) were added and the resulting mixture had a pH of 7.31. The obtained solids were filtered off and washed three times with de-ionized water (each time 1000 ml de-ionized water were used). Subsequently, the solids were dried in an oven in air at 120° C. for 4 h and then calcined in air at 490° C. for 5 h, wherein the heating rate for calcining was 2° C./min.

The resulting product had a Si content of 42 weight-%, a Ti content of 1.5 weight-%, and a total loss of carbon of less than 0.1 weight-%. The BET specific surface area of the resulting product was 449 m²/g, and the water adsorption 9.6 wt.-%. The crystallinity was 96% and no anatase was detectable by X-ray diffraction.

The XANES spectrum of the product was determined, wherein the catalyst displays a ratio of the intensity of the signal at 4987 eV to the intensity of the signal at 4992 eV of 0.98 (1.06:1.08=0.98). The results for the PO test and for the K80-test are shown in tables 4 and 5, respectively.

### Example 4: Preparation of a TS-1 Catalyst in Accordance with the Present Invention

For the gel preparation, 500 g tetraethylorthosilicate (TEOS) and 15 g tetraethylorthotitanate (TEOTi; Merck) were filled into a beaker. Then, a solution of 300 g de-ionized water and 220 g aqueous tetrapropylammonium hydroxide (TPAOH; 40 weight-% in water) was added under stirring (200 rpm). The resulting mixture had a pH of 13.83. The mixture was hydrolyzed at room temperature for 60 min during which the temperature rose to 60° C. The mixture had a pH of 12.71 then. Afterwards the ethanol was distilled off until the sump reached a temperature of 95° C. 558 g of distillate was obtained from distillation.

The synthesis gel was then cooled to 40° C. under stirring and 558 g de-ionized water added thereto. The resulting mixture had a pH of 11.95.

The synthesis gel was then transferred into an autoclave. The synthesis gel was heated under stirring in the autoclave to a temperature of 175° C. and stirred at said temperature for 16 h under autogenous pressure. The pressure was in the range of from 8.4 to 11.4 bar (abs). The resulting suspension was then worked-up. To this effect, the resulting suspension was diluted with de-ionized water, wherein the weight ratio of the suspension to de-ionized water was 1:1. Then, about 152 g nitric acid (10 weight-% in water) were added and the resulting mixture had a pH of 7.21. The obtained solids were filtered off and washed three times with de-ionized water (each time 1000 ml de-ionized water were used). Subsequently, the solids were dried in an oven in air at 120° C. for 4 h and then calcined in air at 490° C. for 5 h, wherein the heating rate for calcining was 2° C./min.

The resulting TS-1 material had a Si content of 43 weight-%, a Ti content of 2 weight-%, and a total loss of carbon of less than 0.1 weight-%. The BET specific surface area of the resulting TS-1 material was 447 m²/g. The crystallinity was 92%, and about 0.5% of anatase were detectable by X-ray diffraction.

Then, 382.0 g deionized water were provided in a beaker. 150.9 g tetrapropylammonium hydroxide (as an aqueous solution comprising 40 weight-% tetrapropylammonium hydroxide) were added under stirring. Subsequently, 71.0 g of the TS-1 material were added. This mixture was homogenized for 30 min. The mixture was then transferred into an autoclave. The mixture was hydrothermally treated at 170° C. for 6 hours. The resulting solids were separated via centrifugation, and the solid residue obtained was washed with deionized water. The resulting solid was dried in air at 120° C. for 4 h and calcined in air at 490° C. for 5 h in an oven.

The resulting TS-1 product had a Si content of 44 weight-%, a Ti content of 1.9 weight-%, and a total loss of carbon of less than 0.1 weight-%. The BET specific surface area of the resulting TS-1 product was 446 m²/g, and the water adsorption 7.25 wt.-%. The crystallinity was 93%, and about 0.7% of anatase were detectable by X-ray diffraction.

The XANES spectrum of the product was determined, wherein the catalyst displays a ratio of the intensity of the signal at 4987 eV to the intensity of the signal at 4992 eV of 1.03 (1.13:1.10=1.03). The results for the PO test and for the K80-test are shown in tables 4 and 5, respectively.

### Example 5: Preparation of a TS-1 Catalyst in Accordance with the Present Invention

A TS-1 zeolite was prepared in accordance with Example 1 of WO 2011/064191 A1 with the exception that 10 weight-% of tetraethyl orthosilicate were used as binder based on the TS1 material.

1072 g de-ionized water were provided in a beaker. Then, 424 g tetrapropylammonium hydroxide (as an aqueous solution comprising 40 weight-% tetrapropylammonium hydroxide) were added under stirring. Subsequently, 200 g of the TS-1 zeolite. This mixture was homogenized for 30 min. The mixture was then transferred in an autoclave, where it was hydrothermally treated at 170° C. for 24 hours. The resulting solids were separated via centrifugation, and the solid residue obtained was washed with deionized water. The resulting solid material was heated in air within 60 min to a temperature of 110° C. and dried at said temperature for 4 h. Then, the resulting solid material was heated in air within 190 min to a temperature of 520° C. and calcined at said temperature for 16 h.

The thus obtained TS-1 material had a Si content of 45 weight-%, a Ti content of 1.7 weight-% and a total loss of carbon of less than 0.1 weight-%. The BET specific surface area was 450 m²/g.

5000 g of aqueous nitric acid (10 weight-% HNO₃ in water) were provided in a glass beaker. Under stirring, 250 g of the TS-1 material were added thereto. The resulting suspension—while being stirred at 250 rpm—was refluxed at 100° C. for 1 hour. For work-up, the resulting solids were separated via centrifugation. The resulting solid material was heated in air within 60 min to a temperature of 120° C. and dried at said temperature for 4 h. Then, the resulting solid material was heated in air within 190 min to a temperature of 500° C. and calcined at said temperature for 5 h.

The thus obtained TS-1 material had a Si content of 45 weight-%, a Ti content of 1.8 weight-% and a total loss of carbon of less than 0.1 weight-%. The BET specific surface area was 453 m²/g, and the water adsorption 7.0 wt.-%. The crystallinity was 97%, and about 1% of anatase were detectable by X-ray diffraction. The results for the PO test and for the K80-test are shown in tables 4 and 5, respectively.

### Example 6: Preparation of a Catalyst in Accordance with the Present Invention

Using a modified synthetic procedure, a TS-1 material was synthesized having an Si content of 44 weight-%, a Ti content of 1.2 weight-%, and a total loss of carbon of less than 0.1 weight-%. The BET specific surface area of the TS-1 material was 429 m²/g, the micropore volume was 0.07 ml/g, the total pore volume was 0.37 ml/g, and the water adsorption 3.4 wt.-%. The crystallinity was 100% as determined by X-ray diffraction.

The XANES spectrum of the product was determined, wherein the catalyst displays a ratio of the intensity of the signal at 4987 eV to the intensity of the signal at 4992 eV of 0.99 (1.07:1.08=0.99). The results for the PO test and for the K80-test are shown in tables 4 and 5, respectively.

### Example 7: Preparation of a Catalyst in Accordance with the Present Invention

Using a modified synthetic procedure, a TS-1 material was synthesized having an Si content of 46 weight-%, a Ti content of 1.2 weight-%, and a total loss of carbon of less than 0.1 weight-%. The BET specific surface area of the resulting TS-1 material was 392 m²/g, the micropore volume was 0.06 ml/g, the total pore volume was 0.39 ml/g, and the water adsorption 4.4 wt.-%. The crystallinity was 89%, and about 0.9% of anatase were detectable by X-ray diffraction.

The XANES spectrum of the product was determined, wherein the catalyst displays a ratio of the intensity of the signal at 4987 eV to the intensity of the signal at 4992 eV of 1.07 (1.16:1.08=1.07). The results for the PO test and for the K80-test are shown in tables 4 and 5, respectively.

### Comparative Example 8: Preparation of a Catalyst of the Prior Art

For the gel preparation, 496.7 g tetraethylorthosilicate (TEOS) and 21.8 g tetraethylorthotitanate (TEOTi; Merck) were filled into a beaker. Then, a solution of 298.3 g de-ionized water and 218.2 g aqueous tetrapropylammonium hydroxide (TPAOH; 40 weight-% in water) was added under stirring (200 rpm). The mixture was hydrolyzed at room temperature for 60 min during which the temperature rose to 60° C. Afterwards the ethanol was distilled off until the sump reached a temperature of 85° C. 450 g of distillate was obtained from distillation.

The synthesis gel was then cooled to 40° C. under stirring and 450 g de-ionized water added thereto. The resulting mixture had a pH of 12.1.

The synthesis gel was then transferred into an autoclave. The synthesis gel was heated under stirring in the autoclave to a temperature of 175° C. and stirred at said temperature for 16 h under autogenous pressure. The resulting suspension was then worked-up. To this effect, the resulting suspension was diluted with de-ionized water, wherein the weight ratio of the suspension to de-ionized water was 1:1. Then, 178.6 g nitric acid (10 weight-% in water) were added. The pH was adjusted to 7 with about 3 ml of NH₄OH solution (25 weight-% NH₄OH in water). The obtained solids were filtered off and washed three times with de-ionized water (each time 1000 ml de-ionized water were used). Subsequently, the solids were dried in an oven in air at 120° C. for 4 h and then calcined in air at 490° C. for 5 h, wherein the heating rate for calcining was 2° C./min.

The resulting TS-1 material had a Si content of 43 weight-%, a Ti content of 2.8 weight-%, and a carbon content of 0.6 weight-%. The BET specific surface area of the resulting TS-1 material was 434 m²/g. The crystallinity was 81%, and about 0.7% of anatase were detectable by X-ray diffraction. The results for the PO test and for the K80-test are shown in tables 4 and 5, respectively.

### Comparative Example 9: Preparation of a Catalyst of the Prior Art

For the gel preparation, 500 g tetraethylorthosilicate (TEOS) and 15 g tetraethylorthotitanate (TEOTi; Merck) were filled into a beaker. Then, a solution of 300 g de-ionized water and 220 g aqueous tetrapropylammonium hydroxide (TPAOH; 40 weight-% in water) was added under stirring (200 rpm). The resulting mixture had a pH of 13.5. The mixture was hydrolyzed at room temperature for 60 min during which the temperature rose to 60° C. The mixture had a pH of 12.6 then. Afterwards the ethanol was distilled off until the sump reached a temperature of 95° C. 540 g of distillate was obtained from distillation.

The synthesis gel was then cooled to 40° C. under stirring and 542 g de-ionized water added thereto. The resulting mixture had a pH of 11.9.

The synthesis gel was then transferred into an autoclave. The synthesis gel was heated under stirring in the autoclave to a temperature of 175° C. and stirred at said temperature for 16 h under autogenous pressure. The pressure was in the range of from 8.4 to 10.9 bar (abs). The resulting suspension was then worked-up. To this effect, the resulting suspension was diluted with de-ionized water, wherein the weight ratio of the suspension to de-ionized water was 1:1. Then, about 164 g nitric acid (10 weight-% in water) were added and the resulting mixture had a pH of 7.35. The obtained solids were filtered off and washed four times with de-ionized water (each time 1000 ml de-ionized water were used). Subsequently, the solids were dried in an oven in air at 120° C. for 16 h and then calcined in air at 490° C. for 5 h, wherein the heating rate for calcining was 2° C./min.

The thus obtained TS-1 material had a Si content of 43 weight-%, a Ti content of 2 weight-% and a total loss of carbon of less than 0.1 weight-%. The BET specific surface area was 462 m²/g, and the water adsorption 11.5 wt.-%. The crystallinity was 88% as determined by X-ray diffraction.

The XANES spectrum of the product was determined, wherein the catalyst displays a ratio of the intensity of the signal at 4987 eV to the intensity of the signal at 4992 eV of 0.97 (1.05:1.08=0.97). The results for the PO test and for the K80-test are shown in tables 4 and 5, respectively.

### Reference Example 1.8: Determination of Activation Factor

For determining the activation factor of the prepared catalysts, the concentration of bridging μ² η²-peroxo species per Ti in the H₂O₂-activated catalyst (“mmol μ-peroxo species/mol Ti”) was determined for the examples and comparative examples according to the method described in Reference Example 1.3, wherein the concentration was determined 15 min and 2 h after having activated the respective samples with hydrogen peroxide.

TABLE 1
Overview of relative values for H₂¹⁷O₂, bridging μ² η²-peroxo (“μ-peroxo”),
and H₂¹⁷O after 15 min and after 2 hours as obtained from the measurements and
application of the quantification protocol described in Reference Example 1.3.

| | | | rel. μ- | | rel. | rel. μ- | rel. |
|---|---|---|---|---|---|---|---|
| | Ti | rel. H₂¹⁷O₂ | peroxo | rel. H₂¹⁷O | H₂¹⁷O₂ | peroxo | H₂¹⁷O |
| | content | (15 min) | (15 min) | (15 min) | (2 h) | (2 h) | (2 h) |
| # | [wt.-%] | [%] | [%] | [%] | [%] | [%] | [%] |
| Ex. 1 | 0.52 | 0.28 | 0.50 | 0.22 | 0.09 | 0.60 | 0.31 |
| Ex. 2 | 1.0 | 0.27 | 0.60 | 0.13 | 0.09 | 0.70 | 0.21 |
| Ex. 3 | 1.5 | 0.34 | 0.58 | 0.08 | 0.04 | 0.82 | 0.14 |
| Comp. | 2.0 | 0.22 | 0.71 | 0.07 | 0.04 | 0.88 | 0.09 |
| Ex. 9 | | | | | | | |
| Ex. 4 | 1.9 | 0.46 | 0.45 | 0.09 | 0.10 | 0.72 | 0.18 |
| Comp. | 2.8 | 0.24 | 0.7 | 0.06 | 0.08 | 0.83 | 0.09 |
| Ex. 8 | | | | | | | |
| Ex. 6 | 1.2 | 0.00 | 0.87 | 0.13 | 0.00 | 0.81 | 0.19 |
| Ex. 7 | 1.2 | 0.00 | 0.80 | 0.20 | 0.00 | 0.74 | 0.26 |
| Ex. 5 | 1.8 | 0.00 | 0.79 | 0.21 | 0.00 | 0.70 | 0.30 |

TABLE 2
Overview of concentrations of H₂¹⁷O₂,
bridging μ² η²-peroxo (“μ-peroxo”), and
H₂¹⁷O after 15 min as calculated
according to Reference Example 1.3 and based
on the value of the respective rel. concentration.

| | | conc. H₂¹⁷O₂ | conc. μ-peroxo | conc. H₂¹⁷O |
|---|---|---|---|---|
| | Ti content | (15 min) | (15 min) | (15 min) |
| # | [wt.-%] | [μmol/mg] | [μmol/mg] | [μmol/mg] |
| Ex. 1 | 0.5 | 0.029 | 0.051 | 0.023 |
| Ex. 2 | 1.0 | 0.057 | 0.127 | 0.027 |
| Ex. 3 | 1.5 | 0.107 | 0.182 | 0.025 |
| Comp. Ex. 9 | 2.0 | 0.092 | 0.295 | 0.029 |
| Ex. 4 | 1.9 | 0.183 | 0.179 | 0.036 |
| Comp. Ex. 8 | 2.8 | 0.140 | 0.408 | 0.035 |
| Ex. 6 | 1.2 | 0.000 | 0.217 | 0.032 |
| Ex. 7 | 1.2 | 0.000 | 0.200 | 0.050 |
| Ex. 5 | 1.8 | 0.000 | 0.298 | 0.079 |

TABLE 3
Overview of concentrations of H₂¹⁷O₂,
bridging μ² η²-peroxo (“μ-peroxo”), and
H₂¹⁷O after 2 h as calculated
according to Reference Example 1.3 and based
on the value of the respective rel. concentration.

| | Ti | conc. H₂¹⁷O₂ | conc. μ-peroxo | conc. H₂¹⁷O |
|---|---|---|---|---|
| | content | (2 h) | (2 h) | (2 h) |
| # | [wt.-%] | [μmol/mg] | [μmol/mg] | [μmol/mg] |
| Ex. 1 | 0.5 | 0.009 | 0.061 | 0.032 |
| Ex. 2 | 1.0 | 0.019 | 0.148 | 0.044 |
| Ex. 3 | 1.5 | 0.013 | 0.257 | 0.044 |
| Comp. Ex. 9 | 2.0 | 0.017 | 0.366 | 0.037 |
| Ex. 4 | 1.9 | 0.040 | 0.286 | 0.071 |
| Comp. Ex. 8 | 2.8 | 0.047 | 0.483 | 0.052 |
| Ex. 6 | 1.2 | 0.000 | 0.202 | 0.047 |
| Ex. 7 | 1.2 | 0.000 | 0.185 | 0.065 |
| Ex. 5 | 1.8 | 0.000 | 0.264 | 0.113 |

TABLE 4
Activation factors after 15 min and results from
catalytic testing of the prepared catalysts.

| | | | ¹⁷O-NMR: | | |
|---|---|---|---|---|---|
| | activation | water | mmol μ- | | |
| | factor | adsorp- | peroxo/ | PO | |
| | (15 min) | tion | mol Ti (15 min) | test | K-80 |
| # | [mmol/mol] | [g/g] | [mmol/mol] | [wt.-%] | test |
| Comp. Ex. 8 | 81.5 | 0.117 | 697 | 7.4 | 0.936 |
| Comp. Ex. 9 | 81.3 | 0.115 | 707 | 8.7 | 0.56 |
| Ex. 3 | 55.7 | 0.096 | 580 | 8.2 | 0.41 |
| Ex. 2 | 51.3 | 0.0845 | 607 | 7.7 | 0.36 |
| Ex. 5 | 55.5 | 0.070 | 793 | 9.3 | 0.23 |
| Ex. 6 | 29.5 | 0.034 | 866 | 10.4* | 0.179 |
| Ex. 4 | 32.6 | 0.0725 | 450 | 9.4 | 0.16 |
| Ex. 1 | 36.8 | 0.075 | 490 | 3.7 | 0.12 |
| Ex. 7 | 35.0 | 0.044 | 797 | 12.1 | 0.55 |

*PO test conducted in accordance with Reference Example 1.6 yet employing only 0.25 g of catalyst instead of 0.5 g.

TABLE 5
Activation factors after 2 h and results from
catalytic testing of the prepared catalysts.

| | | | ¹⁷O-NMR: | | |
|---|---|---|---|---|---|
| | activation | | mmol μ- | | |
| | factor | water | peroxo/ | PO | |
| | (2 h) | adsorption | mol Ti (2 h) | test | K-80 |
| # | [mmol/mol] | [g/g] | [mmol/mol] | [wt.-%] | test |
| Comp. Ex. 8 | 97 | 0.117 | 826 | 7.4 | 0.936 |
| Comp. Ex. 9 | 101 | 0.115 | 876 | 8.7 | 0.56 |
| Ex. 3 | 79 | 0.096 | 821 | 8.2 | 0.41 |
| Ex. 2 | 60 | 0.0845 | 708 | 7.7 | 0.36 |
| Ex. 5 | 49 | 0.070 | 703 | 9.3 | 0.23 |
| Ex. 6 | 27 | 0.034 | 807 | 10.4* | 0.179 |
| Ex. 4 | 52 | 0.0725 | 720 | 9.4 | 0.16 |
| Ex. 1 | 44 | 0.075 | 588 | 3.7 | 0.12 |
| Ex. 7 | 32 | 0.044 | 737 | 12.1 | 0.55 |

*PO test conducted in accordance with Reference Example 1.6 yet employing only 0.25 g of catalyst instead of 0.5 g.

As it can be gathered from the results shown in tables 4 and 5, it has quite surprisingly been found that the catalysts of the examples in accordance with the present invention, thus having an activation factor in the range of from 15 to 80 after 15 min as well as after 2 h, show far lower decomposition rates of H₂O₂ as determined according to the K-80 test than the catalysts according to the comparative examples. In particular, the catalysts according to Comparative Examples 8 and 9 show decomposition rates of H₂O₂ of 0.936 and 0.56, respectively. In contrast thereto, the catalysts of the present invention show at most a decomposition rate of H₂O₂ of 0.41 for the catalyst according to Example 3. The lowest decomposition rate of H₂O₂ is shown by the catalyst according to Example 1 where said rate was 0.12.

In addition, the catalysts according to the present invention show at least a good if not an excellent performance in the PO test, as can be seen from the results shown in tables 4 and 5. In particular, the catalysts according to Examples 4-7 show a better performance in the PO test than the catalysts according to Comparative Examples 8 and 9. In particular, it has quite surprisingly been found that the catalyst according to Example 6 displays an extremely good performance, since it displays the second highest activity in the test although only half of the amount of the catalyst was employed compared to the other samples which were tested.

### CITED LITERATURE

U.S. Pat. No. 4,410,501
WO 2020/074586 A1
C. P. Gordon et al., Nature 2020, 586, 708-713
WO 2011/064191 A1
D. Massiot et al., Magnetic Resonance in Chemistry 2002, vol. 40, p. 70-76

1.-15. (canceled)

16. A catalyst for hydrogen peroxide activation, wherein the catalyst comprises Ti, Si, and O, wherein the catalyst comprises a zeolitic material having a framework structure comprising Ti, Si, and O, wherein the zeolitic material is a TS-1 zeolite, wherein the catalyst displays a water adsorption (W), a concentration (C) of bridging μ² η²-peroxo species per Ti in the H₂O₂-activated catalyst as determined by quantitative ¹⁷O NMR spectroscopy according to Reference Example 1.3, and an activation factor (A) according to formula I, wherein the activation factor is in the range of from 15 to 70 mmol/mol;
wherein in accordance with formula I, the activation factor is the multiplication product of the water adsorption and the concentration of bridging μ² η²-peroxo species per Ti in the H₂O₂-activated catalyst:
$$A = W \times C , \qquad ( I )$$
wherein the catalyst comprises from 1.0 to 1.9 weight-% of Ti, calculated as the element and based on the total weight of the catalyst, and
wherein the catalyst displays a water adsorption in the range of from 1 to 7.9 wt.-%.

17. The catalyst of claim 16, wherein the catalyst displays a XANES spectrum having a ratio of the intensity of the signal at 4987 eV to the intensity of the signal at 4992 eV in the range of from 0.95:1 to 1.07:1.

18. The catalyst of claim 16, the zeolitic material having an Si:Ti molar ratio in the range of from 1 to 250.

19. A method for the preparation of a catalyst molding, comprising
(a) providing a catalyst for hydrogen peroxide activation according to claim 16;
(b) mixing the catalyst provided in step (a) with one or more binders;
(c) optionally kneading of the mixture obtained in step (b);
(d) molding of the mixture obtained in step (b) or (c) to obtain one or more moldings;
(e) optionally drying of the one or more moldings obtained in step (d); and
(f) calcining of the molding obtained in step (d) or (e).

20. The method of claim 19, wherein providing the catalyst in (a) comprises selecting the catalyst among catalysts comprising Ti, Si, and O, wherein the catalyst comprises a zeolitic material having a framework structure comprising Ti, Si, and O, wherein the zeolitic material is a TS-1 zeolite, and displaying
a water adsorption (W), and
a concentration (C) of bridging μ² η²-peroxo species per Ti in the H₂O₂-activated catalyst as determined by quantitative ¹⁷O NMR spectroscopy according to Reference Example 1.3;
wherein the catalyst is selected by calculating an activation factor (A) in accordance with formula I for each of the catalysts, and selecting a catalyst displaying an activation factor in the range of from 15 to 70 mmol/mol, wherein the activation factor is the multiplication product of the water adsorption and the concentration of bridging μ² η²-peroxo species per Ti in the H₂O₂-activated catalyst:
$$A = W \times C . \qquad ( I )$$

21. The method of claim 20, wherein providing the catalyst in (a) comprises selecting the catalyst among catalysts displaying a water adsorption in the range of from 1 to 10 wt.-%.

22. The method of claim 20, wherein providing the catalyst in (a) comprises selecting the catalyst among catalysts displaying a concentration of bridging μ² η²-peroxo species per Ti in the H₂O₂-activated catalyst in the range of from 200 to 1,200 mmol/mol.

23. A catalyst molding comprising a catalyst for hydrogen peroxide activation according to claim 16.

24. A process for the activation of hydrogen peroxide comprising:
(1) providing a reactor comprising a catalyst for hydrogen peroxide activation according to claim 16;
(2) contacting the catalyst or catalyst molding provided in (1) with hydrogen peroxide.

25. The process of claim 24, wherein providing the catalyst in (1) comprises selecting the catalyst among catalysts comprising Ti, Si, and O, wherein the catalyst comprises a zeolitic material having a framework structure comprising Ti, Si, and O, wherein the zeolitic material is a TS-1 zeolite, and displaying
a water adsorption (W), and
a concentration (C) of bridging μ² η²-peroxo species per Ti in the H₂O₂-activated catalyst as determined by quantitative ¹⁷O NMR spectroscopy according to Reference Example 1.3;
wherein the catalyst is selected by calculating an activation factor (A) in accordance with formula I for each of the catalysts, and selecting a catalyst displaying an activation factor in the range of from 15 to 70 mmol/mol, wherein the activation factor is the multiplication product of the water adsorption and the concentration of bridging μ² η²-peroxo species per Ti in the H₂O₂-activated catalyst:
$$A = W \times C . \qquad ( I )$$

26. The process of claim 25, wherein providing the catalyst in (1) comprises selecting the catalyst among catalysts displaying a water adsorption in the range of from 1 to 10 wt.-%.

27. The process of claim 25, wherein providing the catalyst in (1) comprises selecting the catalyst among catalysts displaying a concentration of bridging μ² η²-peroxo species per Ti in the H₂O₂-activated catalyst in the range of from 200 to 1,200 mmol/mol.

28. Use of the catalyst according to claim 16 as a catalyst and/or catalyst component in a reaction involving C—C bond formation and/or conversion.
